(19) United States
(12) Patent Application Publication
(10) Pub. No.: US 2016/0117773 A1
(43) Pub. Date: Apr. 28, 2016

(54) Centralized and Customized Asset Allocation Recommendation and Planning Using Trust Profiling

(71) Applicant: FMR LLC, Boston, MA (US)

(72) Inventors: Zhaoying Lin, Winchester, MA (US); Robert Lindsay Macdonald, Duxbury, MA (US); Su Zhang, Winchester, MA (US); Stephen E. Barkhuff, Watertown, MA (US)

(21) Appl. No.: 14/521,283

(22) Filed: Oct. 22, 2014

(51) Int. Cl. G06Q 40/06

(52) U.S. Cl. CPC G06Q 40/06

(57) ABSTRACT

Methods and apparatuses, including computer program products, are described for generating an asset allocation recommendation using personalized, household, and trust profiling. A personalized asset allocation recommendation combines pre-defined cohort data with client input and generates a personalized roll-down schedule, which is then used in determining the asset projections and optimal withdrawal amount during distribution phase or optimal savings amount during accumulation phase. The personal profile and its associated asset allocation recommendation and asset allocation planning can be displayed dynamically in real-time fashion on a dashboard. A household asset allocation recommendation takes into consideration of various aspects of household needs that involving planning with multiple goals and accounts. The profiling questionnaire data for irrevocable trust is presented dynamically upon the determination of the structure of the irrevocable trust. Based on the conditionally collected data, an asset allocation that balances various beneficiaries' needs is recommended for the irrevocable trust.

### TECHNICAL FIELD

This application relates generally to methods and apparatuses, including computer program products, for determining (i) an asset allocation recommendation using personalized profiling techniques, and (ii) asset allocation planning (including, but not limited to, asset allocation roll-down, asset growth analysis, withdrawal and saving strategy) using simulated asset projections. The techniques for asset allocation recommendation are applied across various areas and levels that range from individual retirement planning, individual planning for multiple goals, household planning with multiple accounts and multiple goals, to special accounts such as an irrevocable trust.

### BACKGROUND

Typical asset allocation planning is applied at the individual level and has two approaches—a generic approach (i.e., one size fits all) and a personalized approach (i.e., tailored to specific needs and circumstances). The generic approach usually considers an investment time horizon and makes assumptions regarding many other aspects of an individual's circumstances. On the other hand, the personalized approach (typically conducted via questionnaires) takes consideration of certain elements of the individual's circumstances, such as the individual's financial situation (i.e., risk taking capacity), risk attitude (i.e., willingness to take risk), and goal planning of the individual's assets. As such, a customized asset allocation planning requires extensive information about the customer and can be complicated, especially when there is missing or unknown information about the customer.

Also, these traditional techniques cannot be applied to asset allocation and goal planning for either multiple goals of an individual or multiple individuals' needs and associated assets in the same household. And, traditional asset allocation methodologies do not provide meaningful recommendations for certain complex investment and asset transfer vehicles, such as irrevocable trusts. When recommending an asset allocation for an irrevocable trust, an advisor should balance the income needs for different beneficiaries, who may have different financial and risk outlooks.

The asset allocation process for an irrevocable trust may rely on an individual trustee's judgment, and often includes “rules of thumb” that may or may not be right for the aggregation of beneficial interests encompassed by the trust. As a result, because of lack of financial knowledge, it can be difficult for the trustee to balance the needs of various beneficiaries and choose the right asset allocation for the trust.

In addition, traditional asset allocation planning uses either a generic ‘one size fits all’ roll-down or a static asset allocation roll-down to perform the asset projection. Using a generic roll-down does not account for an individual's unique circumstances or how these circumstances may change through time. Using a static roll-down, the asset allocation does not change as the user ages or his circumstances change.

Part of the challenge is helping the individual to understand the importance of asset allocation and planning, and its impact on the ending wealth. The average investor may not be knowledgeable about the features of guaranteed income sources that can be used to produce income in retirement and how these guaranteed income sources may change their asset allocation model.

### SUMMARY

Therefore, what is needed is a centralized and customized asset allocation recommendation tool that automatically generates asset allocation recommendations for various needs, such as (i) individual retirement planning, (ii) individual multi-goal planning, (iii) household multi-goal-multi-account planning, and (iv) irrevocable trust planning. The techniques described herein provide the advantage of systematically generating an asset allocation recommendation based on the circumstances of an individual or individuals, a household, or a trust. In recommending an asset allocation for individual retirement planning, when there is not enough information gathered from the individual, relevant default cohort values can be supplied to complete the profiling. The techniques for generating the default values can range from age-appropriate cohort data to multi-dimensional (e.g., specific industry, certain household configuration, and income range limit) cohort data. Another advantage provided by the methods and systems described herein is that the generated asset allocation recommendation is extended beyond the prevailing information as of the current point in time and generates a projection of a customized asset allocation roll-down schedule for successive years based on the individual's circumstances.

In addition, the methods and systems proactively consider information like future guaranteed income sources (social security, pensions or other annuities) and proactively make adjustments to the asset allocation recommendation for other such retirement accounts or future income sources to produce an even more personalized asset allocation model recommendation, which contains more refined asset classes and weights. Also, the techniques provide that users are presented with opportunities to change their profiling data. For example, a user can visually compare multiple sets of profiling data to understand the impact of each set on the roll-down path, as well as end-of-life wealth, as their individual circumstances may change over time. The asset allocation recommendation tool also utilizes the personalized asset allocation roll-down approach to solve two major challenges that investment advisors face: (1) determining the maximum sustainable withdrawal amount and (ii) determining the minimum savings (i.e., annual contribution) amount needed in order to sustainably meet retirement expenses under various market scenarios.

Further, the household multi-goal, multi-account planning techniques described herein take into consideration multiple different goals and accounts that individuals in the same household have. To recommend an asset allocation for a particular household, the techniques evaluate the household's financial situation, the risk tolerance and time horizon of each household goal. To recommend an asset allocation for the household, the techniques also evaluate the aggregated effect of each individual goal within the household and the techniques evaluate complementary effects of each account and any locked positions in the accounts (i.e., assets that are held by other service providers). For example, after the complementary effects are determined, the effective asset allocation for a particular individual or goal may no longer be the same as the initial asset allocation recommendation if there are large locked positions present. The methods and systems described herein also help determine a withdrawal amount for various cash flow needs using a hybrid of dollar-weighted and time-weighted methods.

Also, the irrevocable trust asset allocation recommendation techniques described herein offer the following advantageous features: (i) conditional data gathering and data analysis using a decision-tree structure, (ii) systematically handling complex trust structures, (iii) balancing the interests of multiple, various classes of beneficiaries, and (iv) assessing and balancing individual beneficiary needs within the same class of beneficiaries.

Further, each of the asset allocation recommendation methods and systems described herein can leverage the processing power of a server computing device to provide asset allocation recommendation results substantially in real-time upon receiving the corresponding data inputs. Also, as the data inputs are changed (e.g., by a user), the system can update the asset allocation recommendation results quickly and efficiently, while using fewer computing resources, at least in part because the system has already performed many of the analyses upon an initial set of data inputs and can leverage the data generated from intermediary and final steps of that analysis (e.g., stored in memory) without automatically requiring a fresh re-execution of each part of the analysis.

The invention, in one aspect, features a computerized method for generating an asset allocation recommendation using personalized profiling. A server computing device receives, from a remote computing device, personal data elements of a first person, the personal data elements comprising (i) financial data elements, (ii) demographic data elements, (iii) risk tolerance data elements, and (iv) financial goal data elements. The server computing device inserts default values based upon pre-defined cohort data for any of the received personal data elements that are missing. The server computing device aggregates the received personal data elements and the inserted default values into a personal profile of the first person. The server computing device analyzes the personal profile to generate a recommended asset allocation for the first person that meets one or more financial goals of the first person. The server computing device receives adjustments to the personal profile and generating corresponding adjustments to the recommended asset allocation for the first person. The server computing device transmits the personal profile and the recommended asset allocation for the first person to the remote computing device for display.

The invention, in another aspect, features a system for generating an asset allocation recommendation using personalized profiling. The system comprises a server computing device configured to receive, from a remote computing device, personal data elements of a first person, the personal data elements comprising (i) financial investment data elements, (ii) demographic data elements, (iii) risk tolerance data elements, and (iv) financial goal data elements. The server computing device is further configured to insert default values based upon pre-defined cohort data for any of the received personal data elements that are missing. The server computing device is further configured to aggregate the received personal data elements and the inserted default values into a personal profile of the first person. The server computing device is further configured to analyze the personal profile to generate a recommended asset allocation for the first person that meets one or more financial goals of the first person. The server computing device is further configured to receive adjustments to the personal profile and generating corresponding adjustments to the recommended asset allocation for the first person and transmit the personal profile and the recommended asset allocation for the first person to the remote computing device for display.

The invention, in another aspect, features a computer program product, tangibly embodied in a non-transitory computer readable storage medium, for generating an asset allocation recommendation using personalized profiling. The computer program product includes instructions operable to cause a server computing device to receive, from a remote computing device, personal data elements of a first person, the personal data elements comprising (i) financial investment data elements, (ii) demographic data elements, (iii) risk tolerance data elements, and (iv) financial goal data elements. The computer program product includes further instructions operable to cause the server computing device to insert default values based upon pre-defined cohort data for any of the received personal data elements that are missing. The computer program product includes further instructions operable to cause the server computing device to aggregate the received personal data elements and the inserted default values into a personal profile of the first person. The computer program product includes further instructions operable to cause the server computing device to analyze the personal profile to generate a recommended asset allocation for the first person that meets one or more financial goals of the first person. The computer program product includes further instructions operable to cause the server computing device to receive adjustments to the personal profile and generating corresponding adjustments to the recommended asset allocation for the first person and transmit the personal profile and the recommended asset allocation for the first person to the remote computing device for display.

Any of the above aspects can include one or more of the following features. In some embodiments, display of the recommended asset allocation for the first person on the remote computing device comprises generating a dashboard configured to receive the adjustments to the personal profile and display the corresponding adjustments to the recommended asset allocation for the first person. In some embodiments, the dashboard displays the adjustments to the recommended allocation in real-time.

In some embodiments, the recommended asset allocation comprises a roll-down graph containing an asset allocation recommendation in each of a plurality of future years. In some embodiments, the pre-defined cohort data is based upon an age of the first person and comprises personal data elements for one or more other people that share the first person's age. In some embodiments, the personal data elements of the pre-defined cohort data are averaged across a plurality of the other people.

In some embodiments, the financial data elements comprise at least one of a current source of income available to the first person and a future source of income available to the first person. In some embodiments, the financial data elements further include a composition of the current source of income and a composition of the future source of income. In some embodiments, the future source of income is guaranteed.

In some embodiments, the demographic data elements comprise a current age of the first person, a retirement age of the first person, and an ending age of the first person. In some embodiments, the risk tolerance data elements include a level of investment risk that the first person is willing to assume, a level of investment knowledge attributable to the first person, a level of investment experience attributable to the first person, an amount of emergency fund savings of the first person, and a level of financial security attributable to the first person. In some embodiments, the financial goal data elements comprise an asset amount accrued by the first person on a future date and a withdrawal amount needed by the first person on a future date. In some embodiments, the asset amount accrued by the first person on a future date depends upon a contribution amount made by the first person.

The invention, in another aspect, features a computerized method for generating an asset allocation recommendation using household-based profiling. A server computing device receives, from a remote computing device, household data elements of a plurality of people in a single household, the household data elements comprising (i) household financial data elements, (ii) household risk tolerance data elements, (iii) household goal data elements, and (iv) household goal-account assignment data elements. The server computing device inserts default values based upon pre-defined cohort data for any of the received household data elements that are missing. The server computing device aggregates the received household data elements and the inserted default values into a household profile. The server computing device analyzes the household profile to generate a recommended asset allocation for the household that meets one or more financial goals of the household, and transmits the household profile, the recommended asset allocation for the household, and a recommended asset allocation for each household financial goal to the remote computing device for display.

The invention, in another aspect, features a system for generating an asset allocation recommendation using household-based profiling. The system includes a server computing device configured to receive, from a remote computing device, household data elements of a plurality of people in a single household, the household data elements comprising (i) household financial data elements, (ii) household risk tolerance data elements, (iii) household goal data elements, and (iv) household goal-account assignment data elements. The server computing device is further configured to insert default values based upon pre-defined cohort data for any of the received household data elements that are missing. The server computing device is further configured to aggregate the received household data elements and the inserted default values into a household profile. The server computing device is further configured to analyze the household profile to generate a recommended asset allocation for the household that meets one or more financial goals of the household, and transmit the household profile, the recommended asset allocation for the household, and a recommended asset allocation for each household financial goal to the remote computing device for display.

The invention, in another aspect, features a computer program product, tangibly embodied in a non-transitory computer readable storage medium, for generating an asset allocation recommendation using household-based profiling. The computer program product includes instructions operable to cause a server computing device to receive, from a remote computing device, household data elements of a plurality of people in a single household, the household data elements comprising (i) household financial data elements, (ii) household risk tolerance data elements, (iii) household goal data elements, and (iv) household goal-account assignment data elements. The computer program product includes further instructions operable to cause the server computing device to insert default values based upon pre-defined cohort data for any of the received household data elements that are missing. The computer program product includes further instructions operable to cause the server computing device to aggregate the received household data elements and the inserted default values into a household profile. The computer program product includes further instructions operable to cause the server computing device to analyze the household profile to generate a recommended asset allocation for the household that meets one or more financial goals of the household, and transmit the household profile, the recommended asset allocation for the household, and a recommended asset allocation for each household financial goal to the remote computing device for display.

Any of the above aspects can include one or more of the following features. In some embodiments, the server computing device adjusts an asset allocation of one or more non-locked accounts of the household while keeping other accounts of the household locked, determines a withdrawal amount for various cash flow needs using a hybrid of dollar-weighted and time-weighted methods, calculates a personalized roll-down path from a current planning year to a future planning year, determines whether household assets will exist in the future planning year based upon the personalized roll-down path, optimizes a withdrawal amount associated with the household assets to avoid a shortfall of the household assets during a retirement phase and optimizes a saving amount associated with the household assets to avoid the shortfall of the household assets during a retirement phase.

In some embodiments, display of the recommended asset allocation for the household on the remote computing device comprises generating a dashboard configured to receive adjustments to the household profile and display corresponding adjustments to the recommended asset allocation for the household. In some embodiments, the dashboard displays the adjustments to the recommended allocation in real-time.

In some embodiments, the recommended asset allocation comprises a roll-down graph containing an asset allocation recommendation in each of a plurality of future years. In some embodiments, the pre-defined cohort data is based upon an average age of people in the single household and comprises personal data elements for one or more other people in a household that shares the average age with the single household. In some embodiments, the personal data elements of the pre-defined cohort data are averaged across a plurality of other households.

In some embodiments, the demographic data elements comprise a current age of a person in the household, a retirement age of a person in the household, and an ending age of a person in the household. In some embodiments, the risk tolerance data elements include a level of investment risk that the household is willing to assume for each household financial goal, a level of investment experience attributable to the household, and a level of investment knowledge attributable to the household. In some embodiments, the household financial data elements include an amount of emergency fund savings of the household, a level of financial security attributable to the household, and household account information.

In some embodiments, the household financial goal data elements comprise an asset amount accrued by a person in the household and a withdrawal amount available to a person in the household on a future date. In some embodiments, goal parameters for each household financial goal include a goal start year, a goal end year, a goal asset value, a withdrawal amount from the goal assets, and a contribution amount to the goal assets.

The invention, in another aspect, features a computerized method for generating an asset allocation recommendation for a trust. A server computing device receives, from a remote computing device, investment strategy data elements for a trust. The server computing device determines a structure of the trust based upon the investment strategy data elements. The server computing device determines a set of questions based upon the structure of the trust. The server computing device receives, from the remote computing device, trust data elements in response to the set of questions, the trust data elements comprising (i) trust beneficiary data, (ii) trust liquidity needs data, and (iii) one or more trust distribution schedules. The server computing device analyzes the data elements associated with one or more beneficiaries of the trust to generate a recommended asset allocation for the trust that meets one or more financial goals of the one or more beneficiaries and transmits the recommended asset allocation for the trust to the remote computing device for display.

The invention, in another aspect, features a system for generating an asset allocation recommendation for a trust. The system comprises a server computing device configured to receive, from a remote computing device, investment strategy data elements for a trust. The server computing device is further configured to determine a structure of the trust based upon the investment strategy data elements. The server computing device is further configured to determine a set of questions based upon the structure of the trust. The server computing device is further configured to receive, from the remote computing device, trust data elements in response to the set of questions, the trust data elements comprising (i) trust beneficiary data, (ii) trust liquidity needs data, and (iii) one or more trust distribution schedules. The server computing device is further configured to analyze the data elements associated with one or more beneficiaries of the trust to generate a recommended asset allocation for the trust that meets one or more financial goals of the one or more beneficiaries, and transmit the recommended asset allocation for the trust to the remote computing device for display.

The invention, in another aspect, features a computer program product, tangibly embodied in a non-transitory computer readable storage medium, for generating an asset allocation recommendation for a trust. The computer program product includes instructions operable to cause a server computing device to receive, from a remote computing device, investment strategy data elements for a trust. The computer program product includes further instructions operable to cause the server computing device to determine a structure of the trust based upon the investment strategy data elements. The computer program product includes further instructions operable to cause the server computing device to determine a set of questions based upon the structure of the trust. The computer program product includes further instructions operable to cause the server computing device to receive, from the remote computing device, trust data elements in response to the set of questions, the trust data elements comprising (i) trust beneficiary data, (ii) trust liquidity needs data, and (iii) one or more trust distribution schedules. The computer program product includes further instructions operable to cause the server computing device to analyze the data elements associated with one or more beneficiaries of the trust to generate a recommended asset allocation for the trust that meets one or more financial goals of the one or more beneficiaries, and transmit the recommended asset allocation for the trust to the remote computing device for display.

Any of the above aspects can include one or more of the following features. In some embodiments, display of the recommended asset allocation for the trust on the remote computing device comprises generating a dashboard configured to receive data elements associated with one or more beneficiaries of the trust and display the corresponding recommended asset allocation for the trust. In some embodiments, the dashboard displays the recommended asset allocation in real-time.

In some embodiments, the structure of the trust comprises a Grantor Retained Annuity Trust (GRAT), an Irrevocable Life Insurance Trust (ILIT), a trust having a single beneficiary class, or a trust having a plurality of separate beneficiary classes. In some embodiments, the investment strategy data elements are based upon documentation associated with formation of the trust. In some embodiments, the investment strategy data elements comprise an investment objective of the trust and structure data associated with the trust.

In some embodiments, the demographic data elements comprise a current age of a beneficiary of the trust and a gender of a beneficiary of the trust. In some embodiments, the risk tolerance data elements include a level of investment risk that a beneficiary of the trust is willing to assume, a level of dependence that a beneficiary of the trust has on income from the trust, and a level of financial security attributable to a beneficiary of the trust. In some embodiments, the financial goal data elements for a trust having multiple classes of beneficiaries comprise a withdrawal amount available to a current beneficiary of the trust, a frequency of withdrawals to be made by a current beneficiary of the trust, and an amount of trust corpus to be spent by a remainder beneficiary of the trust. In some embodiments, the withdrawal amount comprises an annual percentage of assets withdrawn from the trust.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for determining an asset allocation recommendation using personalized profiling techniques.

FIG. 2 is a flow diagram of a method for determining an asset allocation recommendation using personalized profiling techniques.

FIG. 3 is an exemplary questionnaire to obtain personal profile data from a user.

FIG. 4 is a detailed block diagram of the individual profiling module, for generating an asset allocation recommendation.

FIG. 5 is a detailed block diagram of the individual profiling module, for generating an asset allocation model recommendation.

FIG. 6 is a detailed block diagram of the individual profiling module, for generating information to be used in an asset allocation recommendation and profiling dashboard.

FIG. 7 is an exemplary layout for an asset allocation recommendation and profiling dashboard user interface.

FIG. 8 is an exemplary individual profiling data slider set to be used in conjunction with the asset allocation recommendation and profiling dashboard user interface.

FIG. 9 is an exemplary asset allocation roll-down graph to be used in conjunction with the asset allocation recommendation and profiling dashboard user interface.

FIG. 10 is a total withdrawal/saving allowed chart and a changed withdrawal/saving allowed chart to be used in conjunction with the asset allocation recommendation and profiling dashboard user interface.

FIG. 11 is a projected asset value graph (at the original withdrawal amount) to be used in conjunction with the asset allocation recommendation and profiling dashboard user interface.

FIG. 12 is a projected asset value graph (at the changed withdrawal amount) to be used in conjunction with the asset allocation recommendation and profiling dashboard user interface.

FIG. 13 is a detailed block diagram of the household profiling module for generating an asset allocation recommendation.

FIG. 14 is a flow diagram of a method for generating an asset allocation recommendation using household-based profiling.

FIG. 15 is an exemplary questionnaire to obtain household profile data from a user.

FIG. 16 is a diagram depicting exemplary goals and related accounts for a household.

FIG. 17 is a detailed block diagram of the household profiling module for generating an account level and complementary goal level asset allocation recommendation.

FIG. 18 is an exemplary data intake form to obtain cash flow data.

FIG. 19 is a detailed block diagram of the irrevocable trust profiling module, for generating an asset allocation recommendation.

FIG. 20 is a flow diagram of a method for generating an asset allocation recommendation for a trust.

FIG. 21 is an exemplary data intake form generated by the separate beneficiary classes data intake module for a trust having separate beneficiary classes.

FIG. 22 is an exemplary data intake form generated by the single beneficiary class data intake module for a trust having one class of beneficiary.

FIG. 23 is an exemplary data intake form generated by the ILIT data intake module for an ILIT trust.

### DETAILED DESCRIPTION

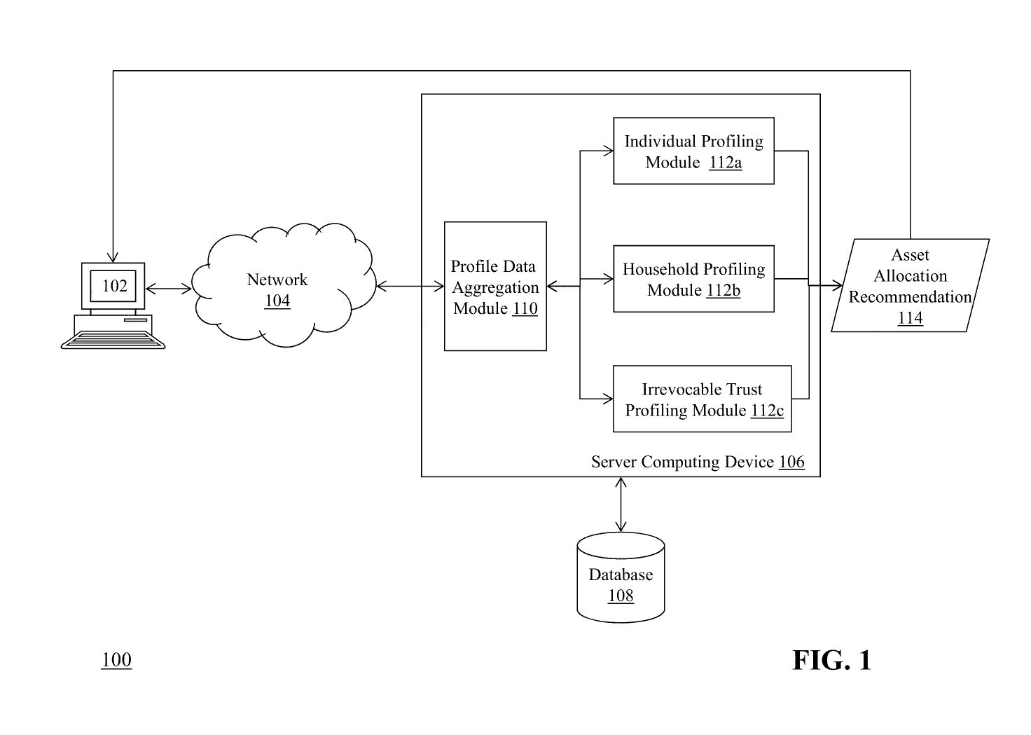

FIG. 1 is a block diagram of a system 100 for determining an asset allocation recommendation using various customized profiling techniques. The system 100 includes a client device 102, a communications network 104, a server computing device 106 coupled to a database 108, several modules 110, 112a-112c included in the server computing device 106, and an asset allocation recommendation 114 as output. In some embodiments, the system 100 automatically selects the corresponding profiling module 112a-112c based on profiling request data. In various embodiments, the system 100 is capable of generating an asset allocation recommendation 114 for an individual, a household, and/or an irrevocable trust.

The client device 102 connects to the server computing device 106 via the communications network 104 in order to initiate the asset allocation recommendation process described herein, and to receive corresponding recommendations and associated information from the server computing device 106. Exemplary client devices include desktop computers, laptop computers, tablets, mobile devices, smartphones, and internet appliances. It should be appreciated that other types of computing devices that are capable of connecting to the server computing device 106 can be used without departing from the scope of invention. Although FIG. 1 depicts a single client device 102, it should be appreciated that the system 100 can include any number of client devices.

The communication network 104 enables the client device 102 to communicate with the server computing device 106 in order to initiate the asset allocation recommendation process described herein, and to receive corresponding recommendations and associated information from the server computing device 106. The network 104 may be a local network, such as a LAN, or a wide area network, such as the Internet and/or a cellular network. In some embodiments, the network 104 is comprised of several discrete networks and/or sub-networks (e.g., cellular to Internet) that enable the client device 102 to communicate with the server computing device 106.

The system 100 also includes a database 108. The database 108 is coupled to the server computing device 106 and stores data used by the server computing device 106 to perform the customer information profiling analysis and asset allocation recommendation generation process. The database 108 can be integrated with the server computing device 106 or be located on a separate computing device. An example database that can be used with the system 100 is MySQL™ available from Oracle Corp. of Redwood City, Calif.

The server computing device 106 is a combination of hardware and software modules that perform the profiling information analysis and asset allocation recommendation generation process described herein, and to transmit the generated recommendations and associated information to remote computing devices (e.g., device 102). The server computing device 106 includes a profile data aggregation module 110, an individual profiling module 112a, a household profiling module 112b, and an irrevocable trust profiling module 112c. The modules 110, 112a-112c are hardware and/or software modules that reside on the server computing device 106 to perform functions associated with the profiling and asset allocation recommendation generation process described herein. In some embodiments, the functionality of the modules 110, 112a-112c is distributed among a plurality of computing devices. It should be appreciated that any number of computing devices, arranged in a variety of architectures, resources, and configurations (e.g., cluster computing, virtual computing, cloud computing) can be used without departing from the scope of the invention. It should also be appreciated that, in some embodiments, the functionality of the modules 110, 112a-112c can be distributed such that any of the modules 110, 112a-112c are capable of performing any of the functions described herein without departing from the scope of the invention. For example, in some embodiments, the functionality of the modules 110, 112a-112c can be merged into a single module. The exemplary functionality of each module 110, 112a-112c will be described in greater detail below.

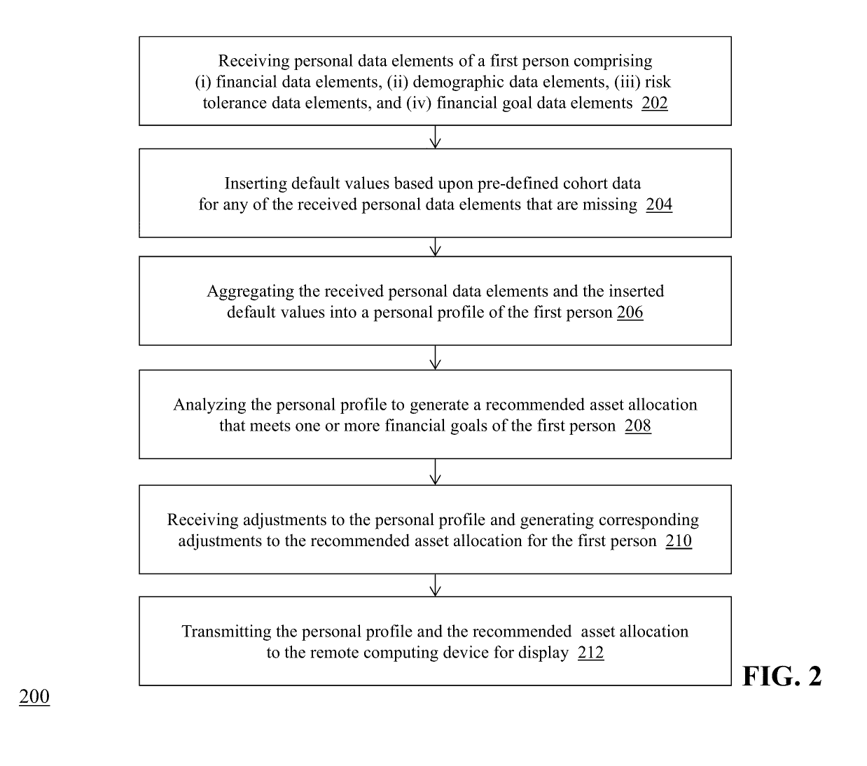

FIG. 2 is a flow diagram of a method 200 for determining an asset allocation recommendation using personalized profiling techniques, using the system 100 of FIG. 1. The profile data aggregation module 110 of the server computing device 106 receives (202) personal data elements of a user (e.g., user at client device 102). The personal data elements comprise (i) financial investment data elements, (ii) demographic data elements, (iii) risk tolerance data elements, and (iv) financial goal (e.g., time horizon) data elements. In some embodiments, the user provides input into a questionnaire or other similar form at the client device 102, and the client device 102 transmits the input to the server computing device 106 via network 104. In some embodiments, the profile data aggregation module 110 collects data elements associated with the user and/or other data elements (such as cohort data) from external data sources, for example, database 108.

The profile data aggregation module 110 determines whether any of the data elements required to perform the profiling and asset allocation recommendation techniques described herein are missing or incomplete. The profile data aggregation module 110 inserts (204) default values based upon pre-defined cohort data for any of the received personal data elements that are missing. For example, if the user at client device 102 provides a current age and a retirement age, but omits an end-of-life age (i.e., the expected lifespan age of the user), the profile data aggregation module 110 can obtain a default value for the ending age based upon retrieval and analysis of age-appropriate cohort data.

It should be appreciated that the default cohort data is not required to be tied to age only. Other default cohort data that can be used includes, but is not limited to, income data, asset data, a combination of age data and income data, and the like.

Age-appropriate cohort data comprises personal data elements that are attributable to other users of the system that are either of the same current age as the user or in the same current age range as the user (e.g., 45-50 years old). The cohort data provides a reasonable estimation of data elements for similar users and can provide reliable default values in the event that the user does not provide, e.g., responses to all of the personal profiling questions at the client device 102. The system's ability to insert default cohort data into the user's personal data elements offers the advantage of a more accurate and robust asset allocation recommendation—even where the user has not provided all of the necessary and/or desired information to process the recommendation.

In some embodiments, certain cohort data can be calculated as follows:
Default retirement age can be based upon the Social Security eligibility age;
Default end-of-life age can be based upon actuarial mortality tables;
Default annual income can be based upon a 3-year rolling average of median incomes;
Default retirement goal asset value can be based upon a 3-year rolling average of median asset values.

Generally, any of the cohort data elements can be determined by using averaging techniques, such as a median with an optional emphasis on more aggressive estimates.

The profile data aggregation module 110 aggregates (206) the received personal data elements and the inserted default values into a personal profile of the user at client device 102. The personal profile serves as the foundation for the system's subsequent analysis and asset allocation recommendation processing. In some embodiments, the personal profile is displayed to the user at client device 102 to confirm whether all of the data elements in the profile are correct. In some embodiments, the profile data aggregation module 110 stores the personal profile in, e.g., database 108.

The profile data aggregation module 110 then transmits the personal profile to one or more of the other modules 112a-112c in the server computing device 106 for analysis and generation of an asset allocation recommendation, depending upon the type of asset allocation recommendation requested by the user at client device 102. For example, if the user at client device 102 would like to receive a personalized asset allocation recommendation for his retirement phase of life, the profile data aggregation module 110 can transmit the user's personal profile to the individual profiling module 112a. In another example, if the user at client device 102 would like to receive an asset allocation recommendation based upon not only his profile but also considering the profiles of other members of his household (e.g., spouse), the profile data aggregation module 110 can transmit the user's personal profile (and in some cases, personal data elements relating to the user's spouse) to the household profiling module 112b. In yet another example, if the user at client device 102 would like to receive an asset allocation recommendation for an irrevocable trust to be established for the benefit of others (e.g., the user's children), the profile data aggregation module 110 can transmit the user's personal profile and in some cases, personal data elements relating to the user's children) to the irrevocable trust profiling module 112c. The operation of and processing performed by these modules 112a-112c will be explained in greater detail below.

Upon receiving the profile data (e.g., for a person, a household, or a trust), the respective module 112a, 112b, and/or 112c analyzes (208) the profile data to generate a recommended allocation of the user's assets that meets one or more financial goals of the user (and in some cases, other people that may be affected by the asset allocation recommendation). The profile data aggregation module 110 can receive (210) adjustments to the personal profile and generating corresponding adjustments to the recommended asset allocation for the first person. The respective module 112a, 112b and/or 112c then transmits (212) the profile and the recommended allocation of the user's assets to a remote computing device (e.g., client device 102) for display.

As set forth above, an initial step in the individual profiling and asset allocation recommendation process described herein is to obtain personal data elements associated with a user that can be used to generate the recommended allocation. An exemplary method of obtaining personal data elements is via a questionnaire or other similar input mechanism, e.g., on a client device 102. A user can provide answers to a series of questions regarding his personal demographic information (e.g., current age, planned retirement age, hypothetical ending age), his personal financial information (e.g., net worth, number of accounts and amount held in each), his personal risk tolerance information (e.g., how much risk is he willing to assume in the short-term and/or long-term to reach his desired retirement assets), and his personal financial goal information (e.g., how much does he want to contribute to the retirement assets annually, how much does he want to be able to withdraw periodically during retirement).

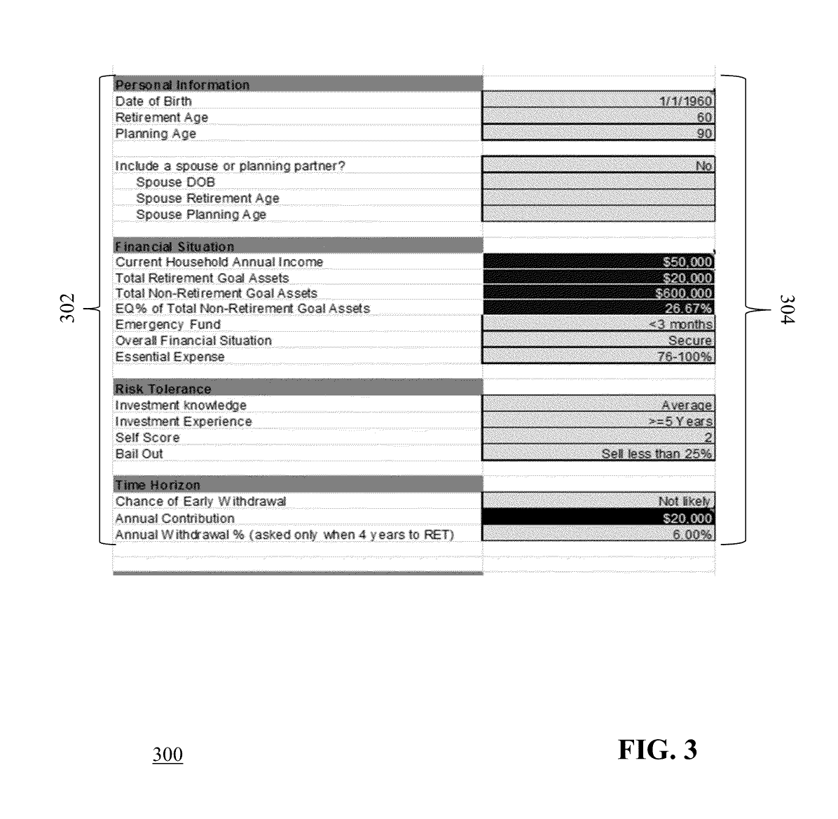

FIG. 3 is an exemplary questionnaire 300 to obtain personal profile data from a user, for example, using client device 102 of system 100. As shown in FIG. 3, the questionnaire 300 includes data element requests 302 in the left-hand column and a user's responses to those data element requests 304 in the right-hand column. In some embodiments, the user can provide the aggregated goal asset to be used. In other embodiments, the user can provide data on detailed retirement accounts; the profile data aggregation module 110 can perform the calculation of the total retirement goal assets for the user.

The user can enter his responses to the data element requests using input devices coupled to the client device 102 and then submit the responses to the server computing device 102. In some embodiments, the user's responses can be submitted to the server computing device 106 via other methods, such a digital version of a paper questionnaire that is scanned to extract the data element requests and responses, and convert them into a digital format (e.g., XML file) which is then submitted to the server computing device 106. Also, it should be appreciated that the questionnaire in FIG. 3 is exemplary, and that other types of data element requests can be used without departing from the spirit and scope of the invention described herein.

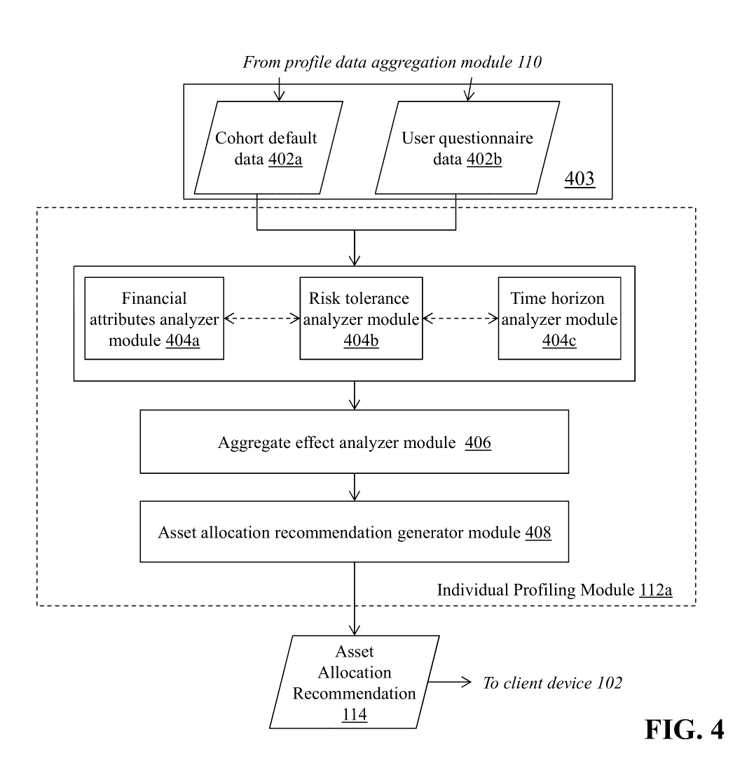

FIG. 4 is a detailed block diagram of the individual profiling module 112a, for analyzing a personal profile of a user and generating an asset allocation recommendation for the user. As described above, the profile data aggregation module 110 receives user questionnaire data 402b from, e.g., client device 102, that contains personal data elements associated with a user to be utilized by the system in generating an asset allocation recommendation. And, in some embodiments, the profile data aggregation module 110 also receives cohort default data 402a from data sources (e.g., database 108) in the event that a portion of the user questionnaire data 402b is missing and/or incomplete.

The profile data aggregation module 110 aggregates the cohort default data 402a (if any) and the user questionnaire data 402b into a personal profile 403 associated with the user. Once the personal profile 403 is generated, the profile data aggregation module 110 transmits the personal profile 403 to one or more of the profiling modules 112a-112c for analysis. As shown in FIG. 4, the profile data aggregation module 110 transmits the personal profile 403 to the individual profiling module 112a for analysis and generation of a personalized asset allocation recommendation for the user.

The individual profiling module 112a receives the personal profile 403 and processes the data elements in the profile using several analyzer modules, including a financial attributes analyzer module 404a, a risk tolerance analyzer module 404b, and a time horizon analyzer module 404c. Each of the analyzer modules 404a-404c performs analyses and calculations using at least a portion of the profile data elements received. For example, the financial attributes analyzer module 404a processes data elements such as the current asset value attributable to the user's accounts, the user's current income, a periodic contribution amount to the user's accounts, percentages of assets invested in particular asset categories, a distribution of assets across various investment accounts, the amount of reserve assets (e.g., an emergency fund) available to the user, and other such data elements. The risk tolerance analyzer module 404b processes data elements such as the user's expressed level of short-term and/or long-term risk that he is willing to assume, the user's investment knowledge and/or experience, and other similar data elements. The time horizon analyzer module 404c processes data elements such as the user's anticipated retirement age, the user's hypothetical end-of-life age, and other similar data elements.

It should be appreciated that each of the analyzer modules 404a-404c can share data elements between each other as the modules 404a-404c process the information. For example, the financial attributes analyzer module 404a can receive a retirement time horizon window from the time horizon analyzer module 404c based upon the module's 404c analysis of the time horizon-related data elements, and the module 404a can use the retirement time horizon window when performing calculations related to, e.g., how the user's asset value will change during retirement based upon periodic withdrawals, or generating an asset allocation recommendation roll-down chart for yearly asset allocation recommendations from the user's current age to the hypothetical end-of-life age, among other applications.

After the analyzer modules 404a-404c have processed the personal profile data elements, the results of the processing are transmitted to the aggregate effect analyzer module 406. The aggregate effect analyzer module 406 evaluates the received results to determine what types of aggregate and/or cumulative effects are generated when the results from the other analyzer modules 404a-404c are merged together. For example, the risk tolerance analyzer module 404b can determine that the user prefers lower-risk investments to achieve his retirement goals, and the financial attributes analyzer module 404a can determine that the user prefers to have a sizeable withdrawal amount during his retirement phase. The aggregate effect analyzer module 406 can combine the above factors to determine that the user's lower-risk investment strategy may not provide enough asset growth over time to fulfill the user's desire for sizable withdrawals. Therefore, the aggregate effect analyzer module 406 can identify this conflict and adjust the data elements to account for the conflict (e.g., by slightly reducing the size of the user's withdrawals for specific time periods during retirement).

Once the aggregate effect analyzer module 406 has analyzed the received data elements, the module 406 transmits the analysis to the asset allocation recommendation generator module 408. The asset allocation recommendation generator module 408 evaluates the analysis from module 406 and determines an asset allocation recommendation for the user. For example, the asset allocation recommendation generator module 408 can generate a detailed yearly asset allocation roll-down that specifies a recommended asset allocation across the user's financial accounts for each year going forward from the present to the end of the planning timeframe. The personalized asset allocation roll-down approach is tailored to the user and is dynamic. For example, as the user's situation changes, the personalized asset allocation roll-down can be updated accordingly. The asset allocation recommendation generator module 408 can transmit the generated asset allocation recommendation 114, e.g., to client device 102 for display and presentation to the user.

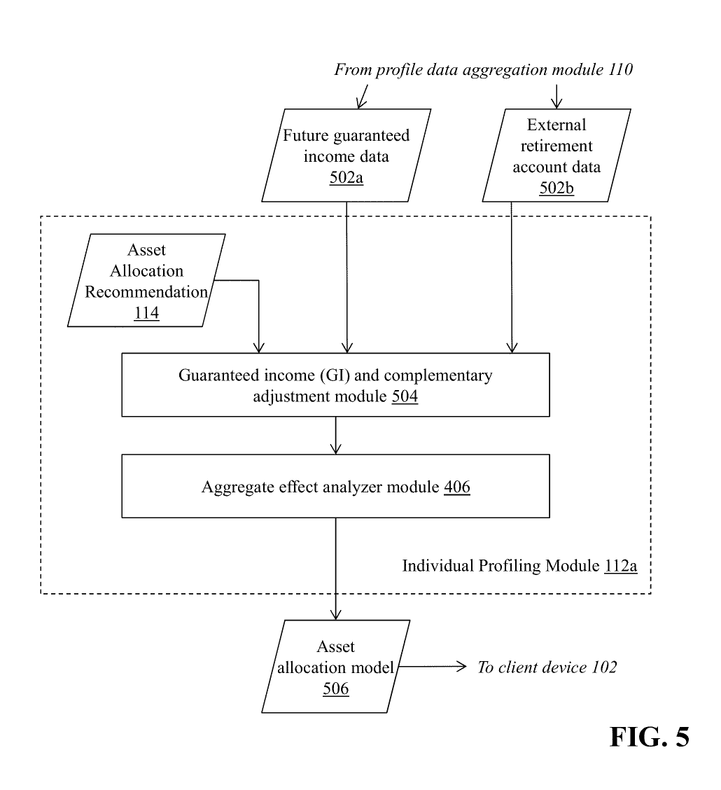

In some embodiments, the individual profiling module 112a can use the asset allocation recommendation 114 as input for further analysis in generating an asset allocation model for the user. FIG. 5 is a detailed block diagram of the individual profiling module 112a, for generating an asset allocation model. As shown in FIG. 5, the individual profiling module 112 receives future guaranteed income data 502a and external retirement account data 502b from the profile data aggregation module 110. The future guaranteed income data 502a, for example, can be income available to the user from sources such as Social Security income, pension income, and other types of future income (like annuity products). The external retirement account data 502b can be income available to the user from retirement account resources that are not managed by the same entity that operates the system 100. For example, the user may hold a variety of retirement accounts with different entities and the system may be offered as a service to the user by one of those entities. The profile data aggregation module 110 can retrieve account data elements associated with the user's external retirement accounts (e.g., by requesting the data elements from computing systems operated by the other entities) and incorporate the external retirement account data elements into the profiling and asset allocation recommendation processing.

The individual profiling module 112a includes a guaranteed income (GI) and complementary adjustment module 504 that receives the asset allocation recommendation 114, the future guaranteed income data 502a and the external retirement account data 502b, and the module 504 analyzes the data to determine whether to adjust the asset allocation recommendation based upon the user's future guaranteed income and/or the user's available external sources of retirement assets (including locked assets). For example, the module 504 can determine that the user will begin receiving a specified amount of Social Security income at age 70. As a result, the module 504 can adjust the user's asset allocation recommendation (including information such as the withdrawal amount available to the user and the total asset value of the user's retirement savings) beginning at age 70 to, e.g., increase the amount of withdrawals that the user can take while still maintaining his goal asset value during the retirement phase. In another example, when the module 504 receives information that specifies the user is to begin receiving Social Security income at age 67, the module 504 can increase the equity portion of the user's asset allocation. When the module 504 receives information that specifies the user has significant equity allocation (e.g., more than desired) in other retirement assets, the module 504 can decrease the equity allocation to the user's retirement assets that are managed by other entities.

Also, as previously described, the aggregate effect analyzer module 406 can evaluate the changes made by the adjustment module 504 to determine whether any conflicts arise with other data elements, such as the user's retirement goals. The aggregate effect analyzer module 406 can generate an asset allocation model 506 based upon its analysis of the data elements processing performed by the adjustment module 504. The asset allocation model represents a refined asset allocation recommendation for the user based upon the initial asset allocation recommendation 114 generated (see FIG. 3), when adjusted for other external and guaranteed income sources available to the user. The aggregate effect analyzer module 406 transmits the asset allocation model 506 to, e.g., the client device 102 for display and presentation to the user.

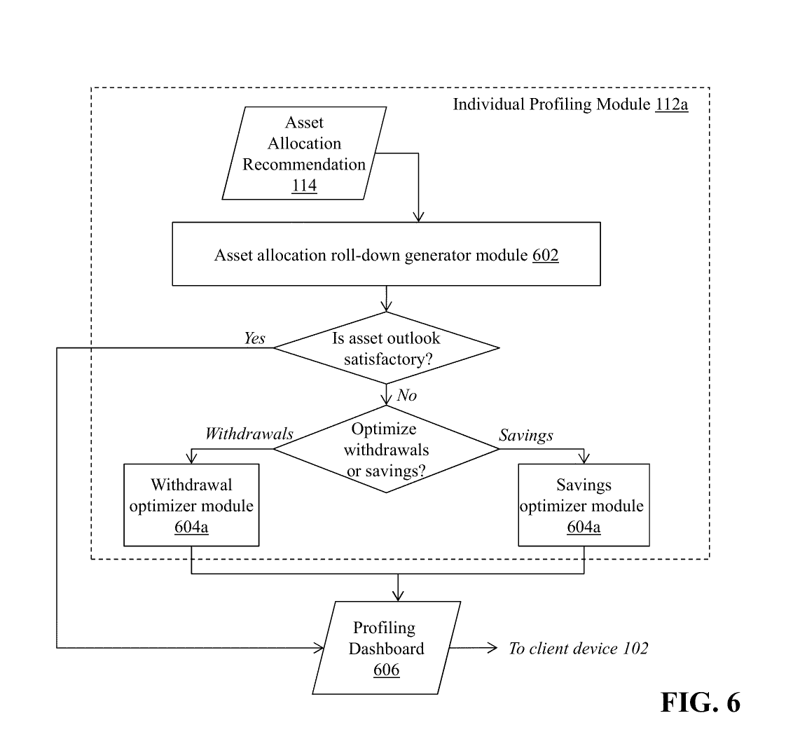

Also, as set forth previously, the individual profiling module 112a can generate an asset allocation roll-down graph based upon the asset allocation recommendation 114 (and/or the asset allocation model 506) for each year going forward from the present to the end-of-planning year. The personalized asset allocation roll-down is then used to project an asset value for each year. In cases where the end-of-planning asset value cannot fulfill the user's goals or needs, the individual profiling module 112a can then optimize the asset allocation roll-down based upon the user's expressed preferences for optimizing withdrawals or savings in the future. FIG. 6 is a detailed block diagram of the individual profiling module 112a, for generating information to be used in an asset allocation recommendation and profiling dashboard 606. As shown in FIG. 6, the individual profiling module 112a includes an asset allocation roll-down generator module 602. The roll-down generator module 602 receives individual profile data and the asset allocation recommendation 114 from FIG. 3, or in some cases the asset allocation model 506 from FIG. 5, and generates an asset allocation roll-down graph and corresponding data (e.g., asset projection graph) to be included in a profiling dashboard. The asset allocation roll-down comprises a per-year recommendation of how the user's assets should be allocated to achieve the user's retirement goals. The roll-down includes periodic changes to the user's asset allocation for future years, typically until the user reaches a hypothetical end-of-life age. The asset projection graph comprises a per-year asset value based upon the asset allocation roll-down.

Once the roll-down has been computed, the individual profiling module 112a can present the roll-down (and other information, such as asset projection, in the dashboard) to the user, e.g., at client device 102 and request input from the user as to whether the asset outlook reflected in the roll-down is satisfactory. For example, if the currently-generated asset allocation roll-down results in the user running out of assets at age 75 in the event of future poor-market conditions, the user can opt to adjust his savings and/or his withdrawals to extend the viability of his asset value for a longer period of time (e.g., to age 95). In another example, if the currently-generated asset allocation roll-down results in the user having a large amount of assets at age 95 in the event of future poor-market conditions, the user can opt to reduce his savings and/or increase his withdrawals to regulate his asset value so that the asset value depletes in a larger amount by age 95 (thereby allowing the user to utilize a greater amount of money during retirement than was originally projected).

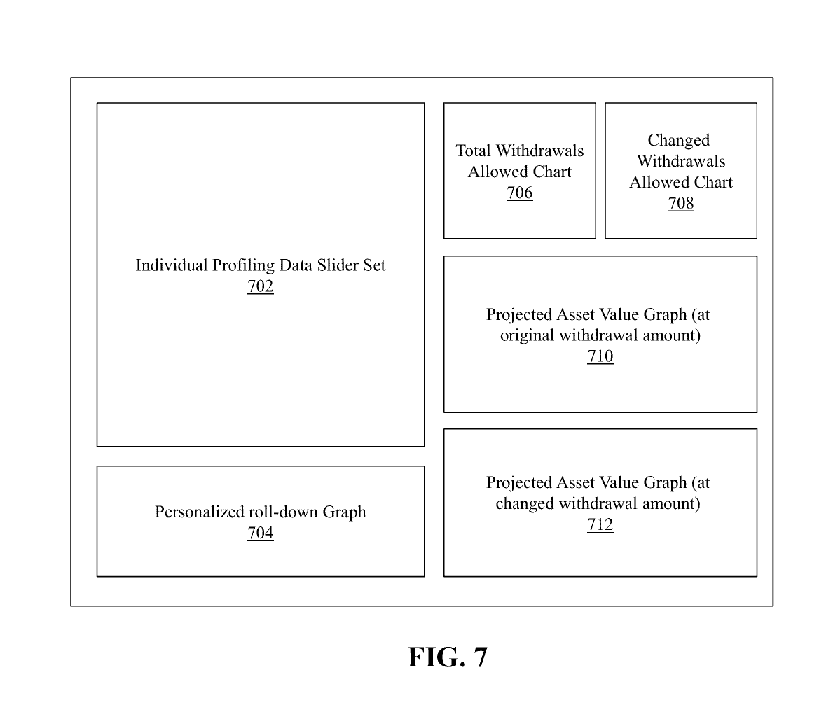

If the asset outlook is satisfactory, that is, the user is satisfied with the asset value he is projected to have at the end of retirement (in the event of future normal-market conditions and/or future poor market conditions), the module 112a can generate a profiling dashboard (shown in FIGS. 7-12) for transmission to the client device 102 and display to the user. If the asset outlook is not satisfactory, the module 112a can request input from the user as to how the roll-down should be optimized (i.e., whether savings or withdrawals should be optimized to reach an end-of-life asset value that meets the user's desired value). Depending upon the user's input, the module 112a can process the asset allocation roll-down through a withdrawal optimizer module 604a or a savings optimizer module 604b that weights the underlying roll-down data in favor of decreased withdrawals during retirement or increased savings accrual and calculates how the asset value will change over time based upon the optimization. The respective optimizer modules 604a-604b can update the profiling dashboard to include the optimized roll-down, projected asset values, and corresponding data, and transmit the updated profiling dashboard to, e.g., the client device 102 for display.

In some embodiments, the withdrawal optimizer module 604a solves for sustainable (e.g., maximum allowed) withdrawal amount under both average (i.e., 50% confidence level) and poor market conditions (i.e., 90% confidence level), so that the assets can last to the end of the planning horizon. Similarly, the saving optimizer module 604b solves for the minimum savings amount needed under both average and poor market conditions, so that the assets can last to the end of the planning horizon. In some embodiments, both optimizer modules 604a-604b utilize personalized roll-downs based upon Monte Carlo simulations. The asset allocation of each year in the roll-down path determines the return for the corresponding year. While adjusting savings and/or withdrawals, the modules 604a-604b can recalculate the roll-down graph simultaneously based on a new saving rate or withdrawal rate. Once the process is completed, resulting in the final optimal savings and/or withdrawal amounts, the optimized roll-down and asset projection graph represent outcomes that satisfy the user's specific retirement needs and goals.

FIGS. 7-12 depict an exemplary profiling dashboard that contains information to be presented to the user on client device 102. The information includes, but is not limited to: (i) a personalized roll-down graph—a forward looking view of personalized asset allocation; (ii) a withdrawal graph—a maximum allowed (sustainable) withdrawal amount; (iii) a savings graph—a minimum required savings amount; (iv) an asset projection graph based upon current savings and/or withdrawal behavior; and (v) an asset projection graph based upon optimal savings and/or withdrawal behavior. With the exception of the personalized roll-down graph, all other graphs (i.e., withdrawal graph, saving graph, asset projection graphs) display outcomes under multiple market scenarios (as set forth above, currently defined as both average and poor market conditions).

FIG. 7 is an exemplary layout for an asset allocation recommendation and profiling dashboard user interface. As shown in FIG. 7, the profiling dashboard comprises several subsections, including an individual profiling data slider set section 702, a personalized roll-down graph section 704, a total withdrawals allowed chart if the user selects to optimize withdrawal amount (or savings chart, if the user selects to optimize savings amount) section 706, a changed withdrawals allowed chart if the user selects to optimize withdrawal amount (or extra savings chart, if the user selects to optimize savings amount) section 708, a projected asset value graph section 710 (at the original withdrawal and/or savings amount), and a projected asset value graph section 712 (at the optimal withdrawal or savings amount depending upon which amount is optimized).

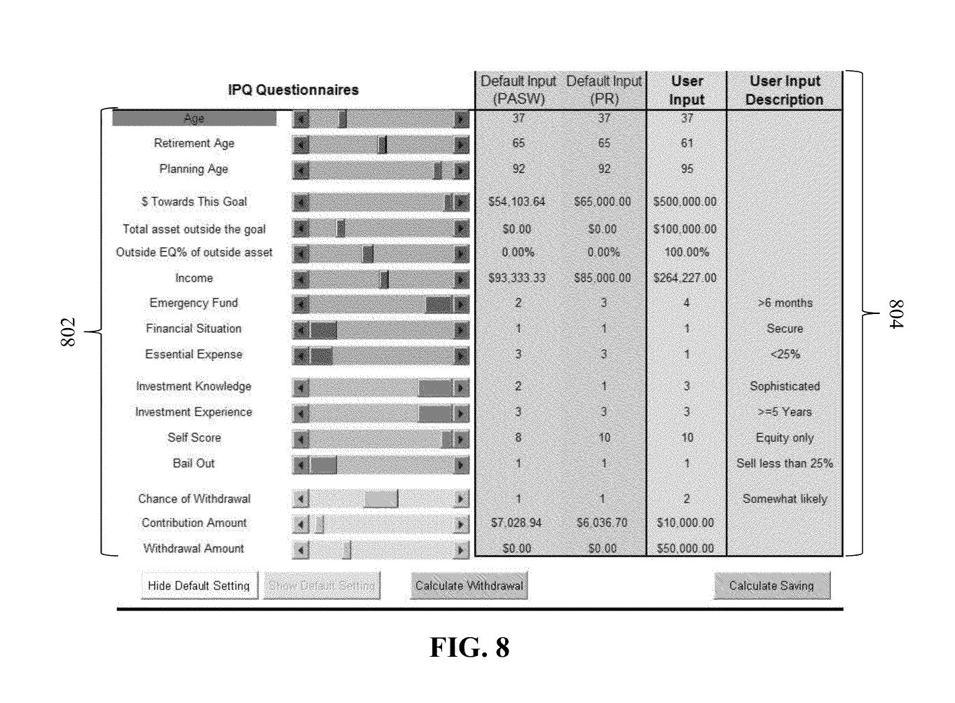

FIG. 8 is an exemplary individual profiling data slider set to be used in conjunction with section 702 in the asset allocation recommendation and profiling dashboard user interface of FIG. 7. As shown in FIG. 8, the slider set includes a plurality of slider input controls 802 that can be controlled by a user at client device 102 to adjust the corresponding values shown in the right-hand portion of the slider set 804. The right hand portion 804 comprises various default input values (e.g., cohort data) that can be used for visual comparison by the user, and user input values that represent the information provided during the questionnaire phase described previously. As the user manipulates the slider set, the user input values change accordingly. The slider set also includes a button to hide the default input values and a button to show the default input values. In addition, the slider set also includes a calculate withdrawal button and a calculate saving button that can be used to optimize the asset allocation recommendation and planning data presented in other sections of the user interface based upon changes made to the slider set, as will be described in greater detail below.

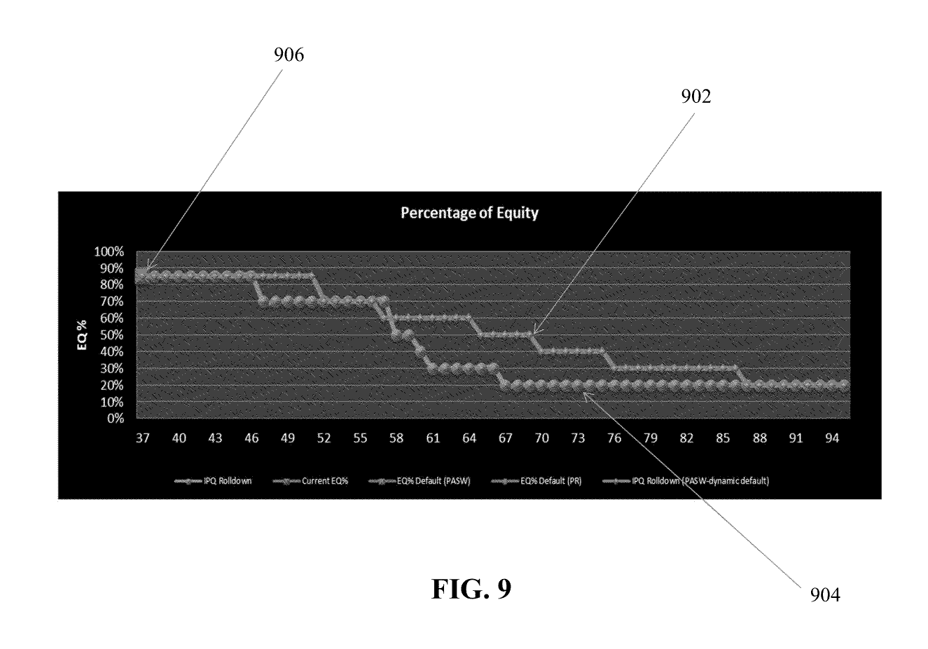

FIG. 9 is an exemplary asset allocation roll-down graph to be used in conjunction with section 704 in the asset allocation recommendation and profiling dashboard user interface of FIG. 7. As shown in FIG. 9, the roll-down graph includes two lines 902, 904 with a series of data points that represent an asset allocation recommendation (depicted as a percentage of assets allocated to equities) for each year in a specified age range (e.g., present day to hypothetical end-of-life age). For example, at the user's current age of 37 (identified using reference character 906), the chart includes a recommendation of asset allocation for the user to be 85% equities. And, for each year into the future until the hypothetical end-of-life age of 95, the chart includes a similar asset allocation recommendation. The line 902 represents a default asset allocation roll-down for the user (e.g., based upon a predetermined asset allocation recommendation using cohort data of a person similar to the user). For example, some entities may simply recommend an automatic roll-down without factoring in any personalized data elements associated with the user. However, line 904 represents the asset allocation roll-down generated by the individual profiling module 112a for the user, based upon the personalized data elements received and analyzed by the module 112a as described above. Different from the generic one-size-fit-all approach, this personalized roll-down provides the advantage of being customized based upon the user's specific financial attributes, demographic information, risk tolerance and retirement goals to achieve a more optimized asset allocation recommendation for the user.

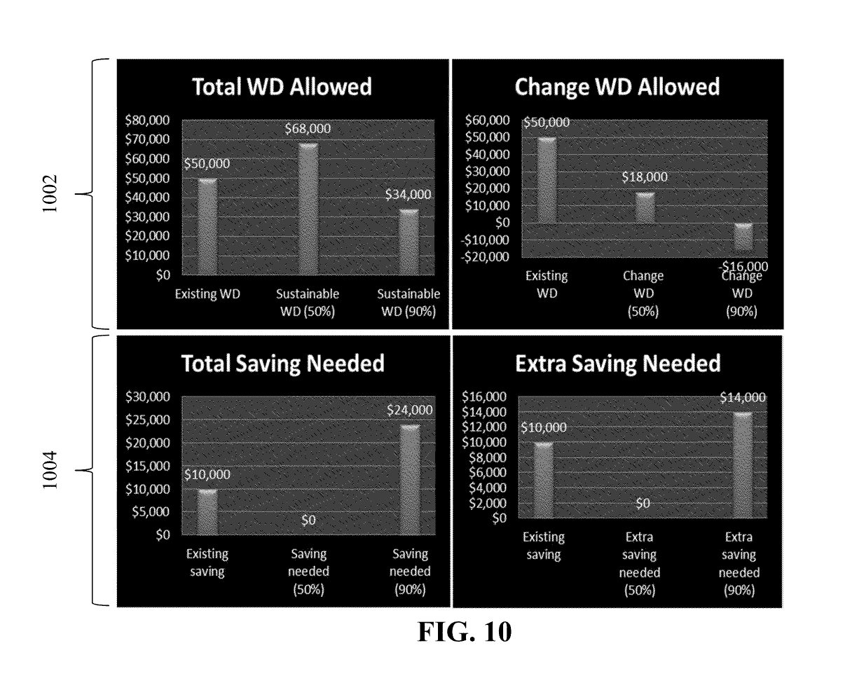

FIG. 10 is an exemplary withdrawal graph 1002 and an exemplary savings graph 1004 when optimization of withdrawals or savings is requested, respectively. Each graph 1002, 1004 has two charts: (i) a total withdrawal/saving allowed chart; and (ii) a changed withdrawal/saving chart, respectively. The charts are used in conjunction with sections 704 and 706 in the asset allocation recommendation and profiling dashboard user interface of FIG. 7 depending upon whether the withdrawal optimizer or the savings optimizer is requested.

As shown in FIG. 10, the total withdrawal allowed chart comprises three bars that represent: (i) the user's current specified withdrawal amount; (ii) the withdrawal amount that is sustainable for the user in the event of future average-market conditions (e.g., 50% confidence level); and (iii) the withdrawal amount that is sustainable for the user in the event of future poor-market conditions (e.g., 90% confidence level). The changed withdrawals allowed chart comprises three bars that represent: (i) the user's current specified withdrawal amount; (ii) the difference between the original specified withdrawal amount and the withdrawal amount that is sustainable for the user in the event of future average-market conditions; and (iii) the difference between the original specified withdrawal amount and the withdrawal amount that is sustainable for the user in the event of future poor-market conditions.

Also as shown in FIG. 10, the total savings needed chart comprises three bars represent: (i) the user's current annual savings; (ii) the savings needed to support the user's specified withdrawal amount during the retirement phase under future average-market conditions; and (iii) the savings needed to support the user's specified withdrawal amount during the retirement phase under future poor-market conditions. The extra savings needed chart comprises three bars that represent: (i) the user's current annual savings; (ii) the extra savings needed to support the user's specified withdrawal amount during the retirement phase under future average-market conditions; and (iii) the extra savings needed to support the user's specified withdrawal amount during the retirement phase under future poor-market conditions.

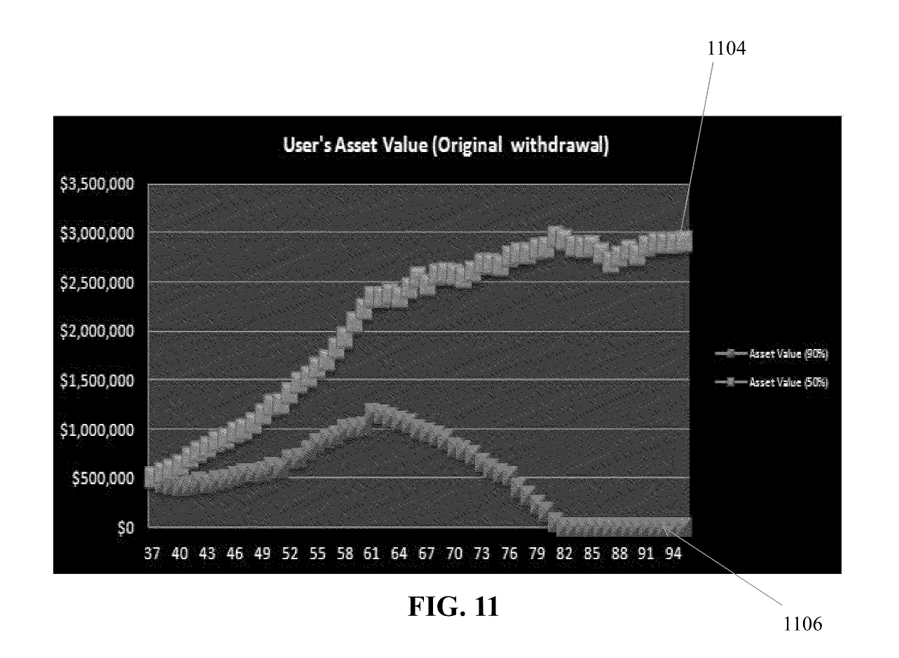

FIG. 11 is a projected asset value graph (at the original withdrawal and savings amount) to be used in conjunction with section 710 in the asset allocation recommendation and profiling dashboard user interface of FIG. 7. The projected asset value graph comprises two lines 1104, 1106 that represent the total asset value for the user at each year in the future, for either average-market conditions (line 1104) or poor-market conditions (line 1106). As shown in FIG. 11, if the user takes the original withdrawal amount from his asset pool (starting, e.g., at retirement age 61), line 1104 shows that, during future average-market conditions, his asset value continues to grow to age 95. Alternatively, if the user takes the original withdrawal amount from his asset pool starting at retirement age 61, line 1106 shows that, during future poor-market conditions, his asset value will deplete to zero by age 82. Based on this analysis, the user may wish to either reduce his withdrawal amount or increase his savings amount so as to ensure his asset value remains above zero to a hypothetical end-of-life age of 95.

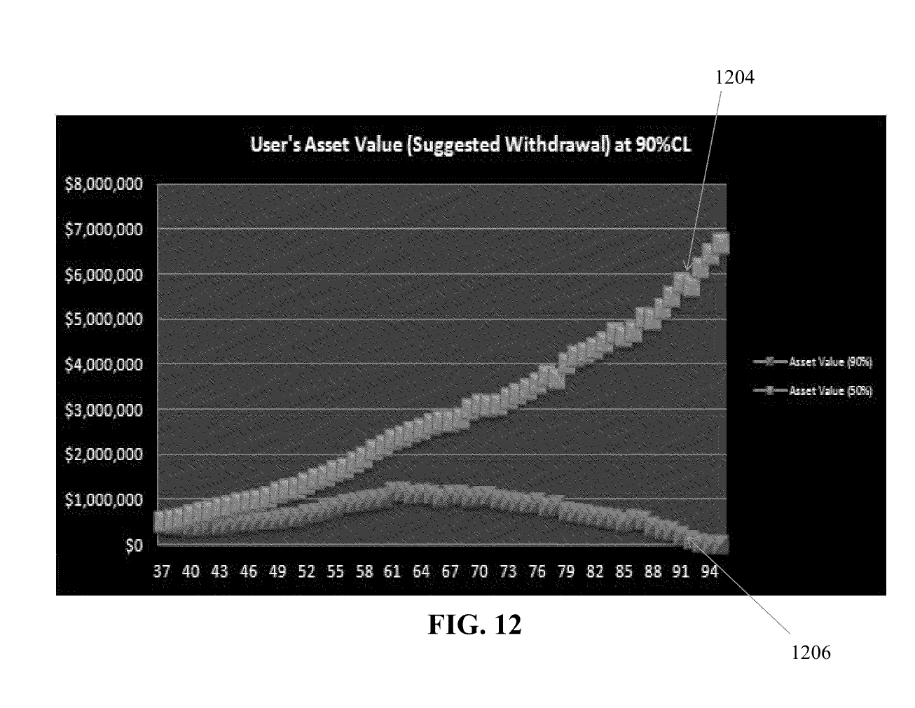

FIG. 12 is a projected asset value graph (at the suggested withdrawal amount, assuming the user chooses to reduce his withdrawal amount) to be used in conjunction with section 712 in the asset allocation recommendation and profiling dashboard user interface of FIG. 7. If the user chooses to increase the savings amount, the corresponding asset projection with the suggested savings amount is used. The projected asset value graph comprises two lines 1204, 1206 that represent the total asset value for the user at each year in the future, for either average-market conditions (line 1204) or poor-market conditions (line 1206). As shown in FIG. 11, if the user takes the suggested withdrawal amount from his asset pool (starting, e.g., at retirement age 61), line 1204 shows that, during future average-market conditions, his asset value continues to grow substantially to age 95. Alternatively, if the user takes the suggested withdrawal amount from his asset pool starting at retirement age 61, line 1206 shows that, during future poor-market conditions, his asset value will deplete to zero at the hypothetical end-of-life planning age of 95.

It should be appreciated that the system 100 is capable of dynamically adjusting the visual representations of the asset allocation recommendation data in FIGS. 9 and 11 according to changes made by the user to the slider set in FIG. 8. These real-time visual representations provide the advantage of enabling the user to better understand the importance of asset allocation decisions and associated consequences. Also, the user is able to identify a shortfall immediately and rely on the asset allocation recommendation tool to recommend savings or spending behavior to avoid the shortfall, so as to have a sustainable retirement life.

As described above, the system 100 can transmit the profiling dashboard 606 to the client device 102 for display to and interaction by a user. In some embodiments, the system 100 can store the profiling dashboard data and transmit part or all of the information to the user in other ways (e.g., email or paper reports).

Household-Based Asset Allocation Recommendations—Multi-Goal, Multi-Account Planning

Another advantage of the systems and methods described herein is the ability to generate asset allocation recommendations for a household with multiple goals and multiple accounts. As described previously, the server computing device 106 of FIG. 1 includes a household profiling module 112b capable of receiving data elements from the profile data aggregation module 110 and generating an asset allocation recommendation 114 based upon data from a household that multiple accounts that are assigned to different goals.

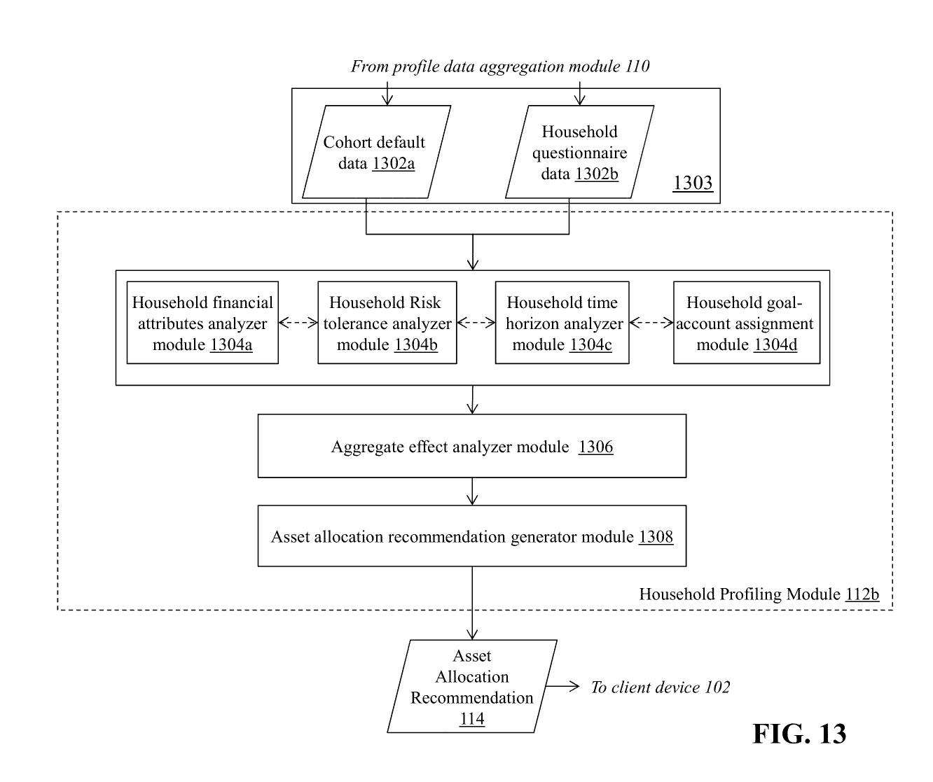

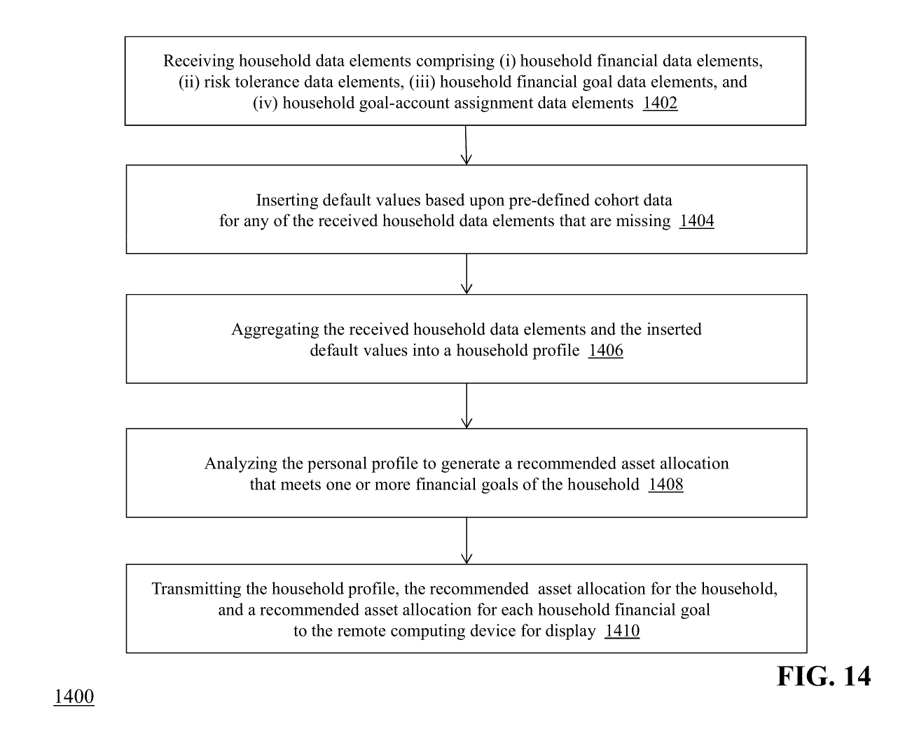

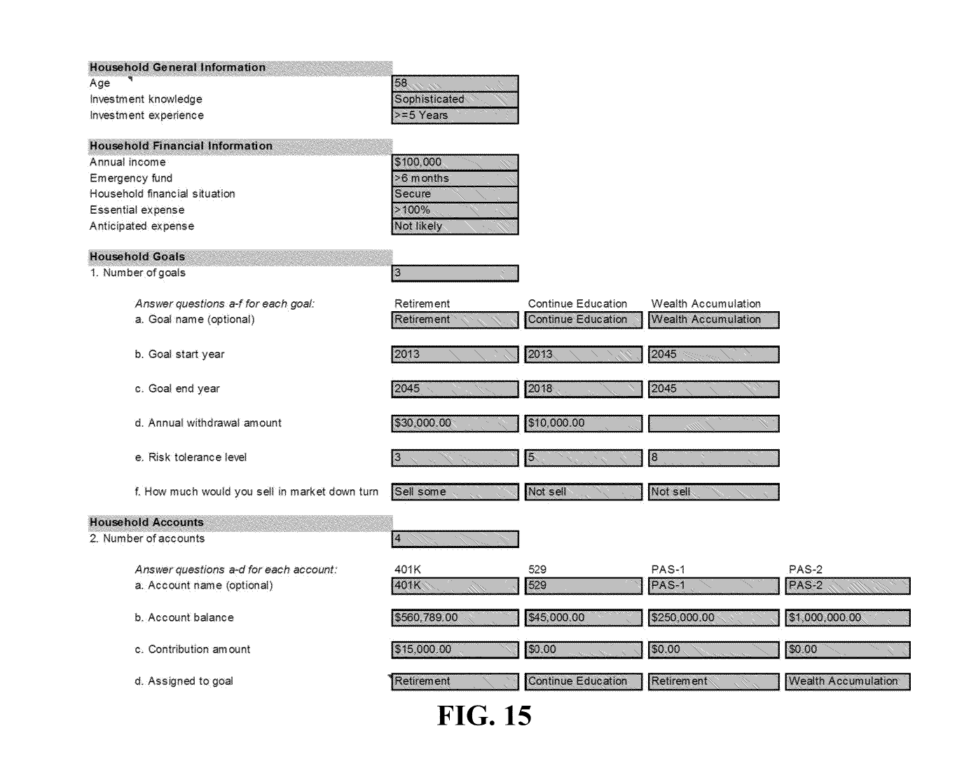

FIG. 13 is a detailed block diagram of the household profiling module 112b for generating an asset allocation recommendation. FIG. 14 is a flow diagram of a method 1400 for generating an asset allocation recommendation using household-based profiling. The profile data aggregation module 110 receives (1402) household questionnaire data 1302b from, e.g., client device 102, that contains household data elements associated with multiple goals to be utilized by the system in generating an asset allocation recommendation for a household. In some examples, the household questionnaire data 1302b includes the user questionnaire data described previously for multiple goals (e.g., goals could be those other than retirement) within a household. FIG. 15 is an exemplary questionnaire to obtain household profile data from a user. And, in some embodiments, the profile data aggregation module 110 also inserts (1404) cohort default data 1302a from data sources (e.g., database 108) in the event that a portion of the household questionnaire data 1302b is missing and/or incomplete.

The profile data aggregation module 110 aggregates (1406) the cohort default data 1302a (if any) and the household questionnaire data 1302b into a household profile 1303 associated with the household. Once the household profile 1303 is generated, the profile data aggregation module 110 transmits the household profile 1303 to the household profiling module 112b for analysis and generation of a personalized household asset allocation recommendation.

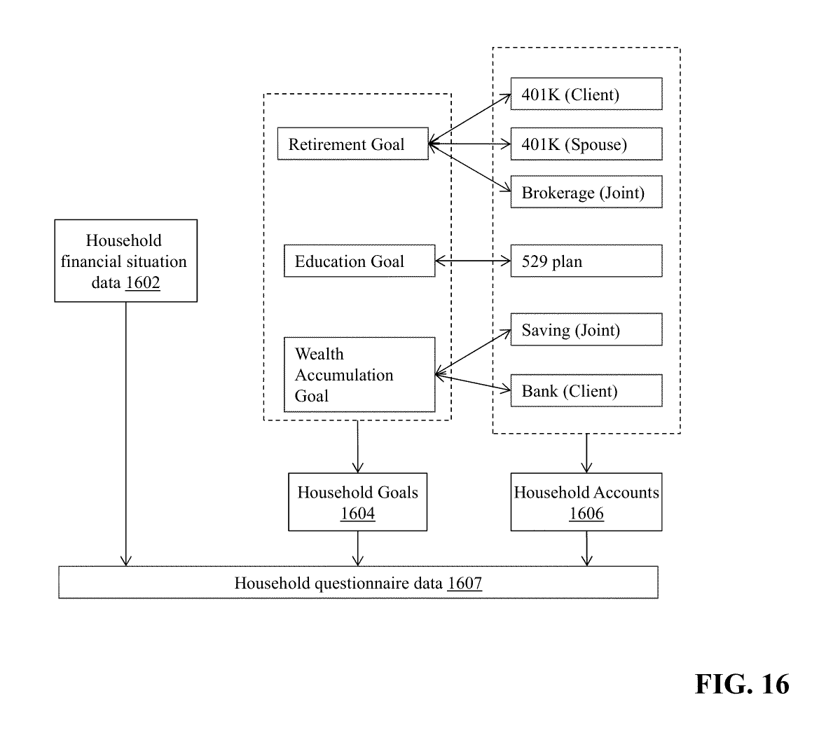

FIG. 16 is a block diagram depicting exemplary goals and related accounts for a household. As shown in FIG. 16, the household financial situation data 1602, the household goals data 1604 and the household accounts data 1606 together form the household questionnaire data 1607. The household goals data 1604 contains information about the goals (e.g., retirement goal, education goal, wealth accumulation goal), such as goal start, goal end, risk attitude towards the goal, and withdrawal needs upon reaching the goal. The household accounts data 1606 (relating to, e.g., 401K accounts, brokerage accounts, 529 plan accounts, savings accounts, bank accounts, and the like) contains information about the account balance, current asset allocation, saving into the account, and assignment to one or more goals. FIG. 16 illustrates that the household multi-goal-multi-account planning techniques can take multiple goals desired by a household, and multiple accounts that the household designates to each goal.

Turning back to FIGS. 13 and 14, the household profiling module 112b receives the household profile 1303 and analyzes (1408) the data elements in the profile using several analyzer modules, including a household financial attributes analyzer module 1304a that evaluates the household financial situation (i.e., capability to take risk), a household risk tolerance analyzer module 1304b that evaluates the willingness to take risk for each goal, and a household time horizon analyzer module 1304c that evaluates the specific needs for each goal, and a household goal-account assignment module 1304d that evaluates the assets allocated to each goal. Each of the analyzer modules 1304a-1304d performs analyses and calculations using at least a portion of the household profile data elements received. For example, the household financial attributes analyzer module 1304a processes data elements such as the household's current income, a periodic contribution amount to the plurality of users' accounts, the amount of reserve assets (e.g., an emergency fund) available to the household, the outlook of the household's financial situation, and other such data elements. The household risk tolerance analyzer module 1304b processes data elements such as the expressed level of short-term and/or long-term risk that the household is willing to assume for each goal, the household's investment knowledge and/or experience, and other similar data elements. The household time horizon analyzer module 1304c processes data elements such as the goal start age, goal end age, how the goal assets are to be distributed, and other similar data elements. The household goal-account assignment module 1304d processes data elements such as how accounts are assigned to each goal, what is the account asset allocation, and other similar data elements.

It should be appreciated that each of the analyzer modules 1304a-1304d can share data elements between each other as the modules 1304a-1304d process the information. For example, the financial attributes analyzer module 1304a can receive a retirement time horizon window from the time horizon analyzer module 1304c based upon the module's 1304c analysis of the time horizon-related data elements, and the module 1304a can use the retirement time horizon window when performing calculations related to, e.g., how the plurality of users' asset value will change during retirement based upon periodic withdrawals, or generating an asset allocation recommendation roll-down chart for yearly asset allocation recommendations from a user's current age to the hypothetical end-of-life age of the eldest user, among other applications.

After the analyzer modules 1304a-1304d have processed the household profile data elements, the results of the processing are transmitted to the aggregate effect analyzer module 1306. The aggregate effect analyzer module 1306 evaluates the received results to determine what types of aggregate and/or cumulative effects are generated when the results from the other analyzer modules 1304a-1304d are merged together. For example, the household financial attributes analyzer module 1304a can determine that the household has enough emergency funds, has sizable assets and is financially stable. The household risk tolerance analyzer module 1304b can determine that the household prefers lower risk for an education goal while the household prefers moderate risk for a retirement goal and high risk for a wealth accumulation goal. The household time horizon analyzer module 1304c can determine that the education goal has a short time horizon with large withdrawals in a short period, the retirement goal is twenty years out, and the wealth accumulation goal is fifty years out. The household goal-account assignment module 1304d can determine that the household devotes half of their assets to the retirement goal, three-eighths of their assets to the education goal and one-eighth of their assets to the wealth accumulation goal. The aggregate effect analyzer module 1306 can combine the above factors to determine how they individually and cumulatively impact the asset allocation of each goal and the entire household.

Once the aggregate effect analyzer module 1306 has analyzed the received data elements, the module 1306 transmits the analysis to the asset allocation recommendation generator module 1308. The asset allocation recommendation generator module 1308 evaluates the analysis from module 1306 and determines an asset allocation recommendation for each goal, and each goal level asset allocation is rolled up to derive the household asset allocation. The asset allocation recommendation generator module 1308 transmits (1410) the generated household asset allocation recommendation 114, e.g., to client device 102 for display and presentation to the user.

Another feature provided by the household asset allocation recommendation techniques described herein is a dollar-to-dollar complementary adjustment for managed assets. As described above, the asset allocation recommendation generator module 1308 determines the asset allocation for each goal, which implies that all the accounts assigned to the same goal follow the same asset allocation. However, when the user does not adjust certain accounts to the desired asset allocation for those accounts, the system can “lock” the account to its current asset allocation and attempt to change the non-locked account allocation with the goal to keep the desired goal level asset allocation.

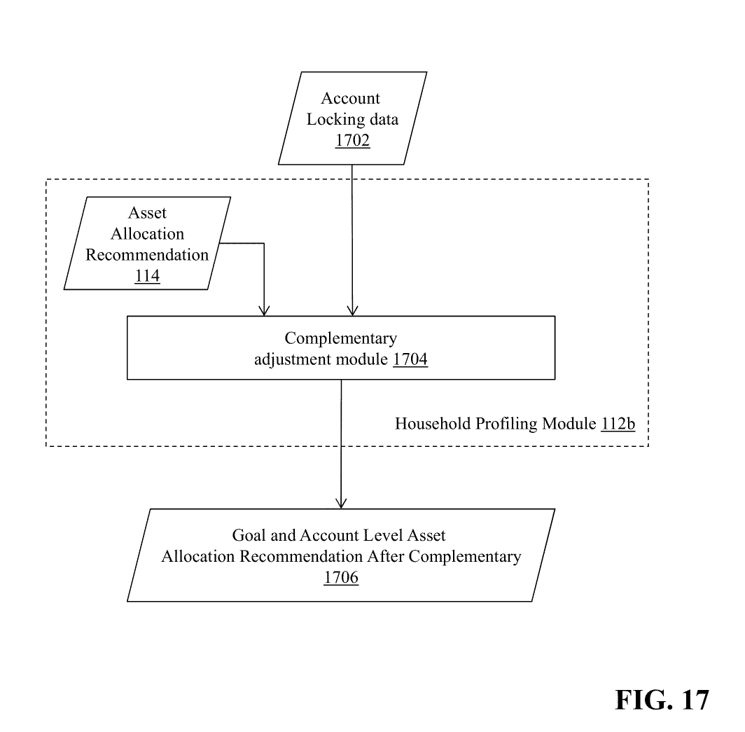

FIG. 17 is a detailed block diagram of the household profiling module 112b for generating an account level and complementary goal level asset allocation recommendation. The original goal asset allocations from the asset allocation recommendation 114 in conjunction with the account locking data 1702 are passed to the complementary adjustment module 1704, which attempts to achieve the original goal level asset allocation by adjusting the asset allocation for the non-locked account (e.g., dollar-to-dollar) with certain accounts' asset allocation being locked to result in a goal and account level asset allocation recommendation after complementary processing 1706. For example, due to the limitation of equity assets held in an account (0-100%), the complementary goal level asset allocation may differ from the original goal level asset allocation.

In some embodiments, the asset allocation recommendation 114 generated by the household profiling module 112b can provide multiple recommendations based upon specific aspects of the household. For example, the recommendation 114 can include a recommended asset allocation for each goal in the household. In another example, the module 112b can provide an asset allocation recommendation for the household in its entirety, or for each account in the household. The module 112b can also provide an effective asset allocation recommendation based upon each goal in the household, after compensation is made for certain attributes (e.g., locked external accounts). Note that the effective asset allocation may not in all cases equal the goal asset allocation.

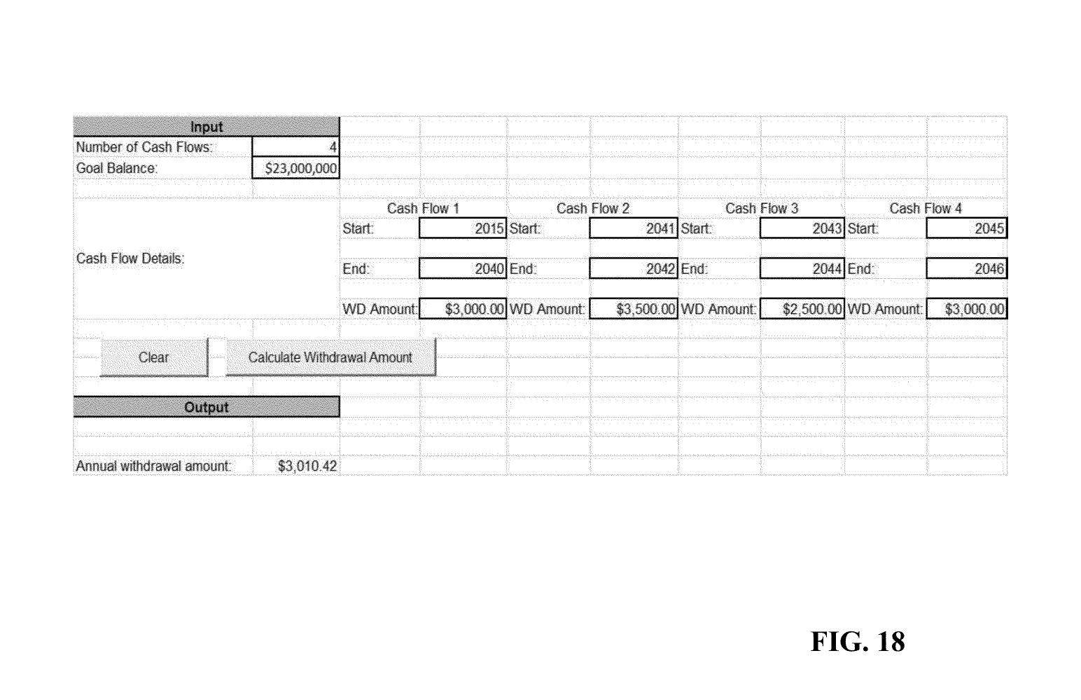

Another feature provided by the household asset allocation recommendation techniques described herein is the capability to calculate the withdrawal amount for various cash flow needs using a hybrid of dollar-weighted and time-weighted methods. Often, a user may not be able to know the annualized withdrawal amount for a particular goal—especially when the withdrawal needs varies. FIG. 18 is an exemplary questionnaire to obtain household cash flows data from a user. As shown in FIG. 18, the user can provide the number of cash flows, the goal balance, and the cash flow details for each cash flow.

Irrevocable Trust Asset Allocation Recommendations

Another advantage of the systems and methods described herein is the ability to generate asset allocation recommendations for use in conjunction with various types of investment vehicles, including but not limited to irrevocable trusts. The methods and systems described herein provide an asset allocation recommendation based upon the structure of the trust, rather than being limited to a generic, universally applied asset allocation recommendation (e.g., ‘balanced’ or 50% equity) without understanding the unique characteristics of the trust.

The irrevocable trust profiling module 112c has the following unique features: (i) conditional data gathering and analysis using a decision tree, that is the questionnaire data is presented conditionally based on response to each previous question; (ii) handling complex trust structures systematically; (iii) balancing the interests of various classes of beneficiaries; and (iv) assessing and balancing individual beneficiaries within the same class.

The following are examples of trusts that can be evaluated using the systems and methods described herein:

Irrevocable trust with separate classes of beneficiaries: Analysis of this type of trust begins with an assumed baseline asset allocation. The trust's stated investment objective plays a role in determining an asset allocation for the trust. One goal is to balance the needs of current and future beneficiaries. Other information that is relevant to an asset allocation is: any income beneficiary's circumstances and liquidity needs, any remainder beneficiary's circumstances and corpus usage, stated priority among beneficiaries, and charitable status of the trust.

Irrevocable trust with a single class of beneficiaries: Analysis of this type of trust begins with an assumed baseline asset allocation. Information such as the trust's investment objectives, the beneficiary's circumstances, the beneficiary's withdrawal/liquidity needs, the trust distribution schedule, and corpus usage after distribution are considered in the asset allocation determination process.

Grantor Retained Annuity Trust (GRAT): A GRAT analysis begins with an assumed baseline asset allocation. One general approach is that the stronger the grantor's financial situation is, the more aggressive the asset allocation for the GRAT can be. Similarly, the higher risk tolerance the grantor has, the more aggressive the asset allocation for the GRAT can be. Another factor that will impact the asset allocation is the GRAT's investment objective (e.g., the more aggressive the investment objective is, the more aggressive the asset allocation for the GRAT can be).

Irrevocable Life Insurance Trust (ILIT): An ILIT begins with an assumed baseline asset allocation. Various data elements, such as the policy term, grantor circumstances (e.g., age, financial situation, risk tolerance), beneficiary circumstances (e.g., age, interest financial situation, and risk tolerance), and investable asset usage (e.g., withdrawal information for the investable assets) affects the asset allocation. Another factor impacting the asset allocation for the ILIT is the investment objective, the more aggressive the investment objective is, the more aggressive the asset allocation for the ILIT can be.

As described previously, the server computing device 106 of FIG. 1 includes an irrevocable trust profiling module 112c that is capable of receiving data elements from the profile data aggregation module 110 and generating an asset allocation recommendation 114 based upon data associated with a proposed or currently-in-effect irrevocable trust.

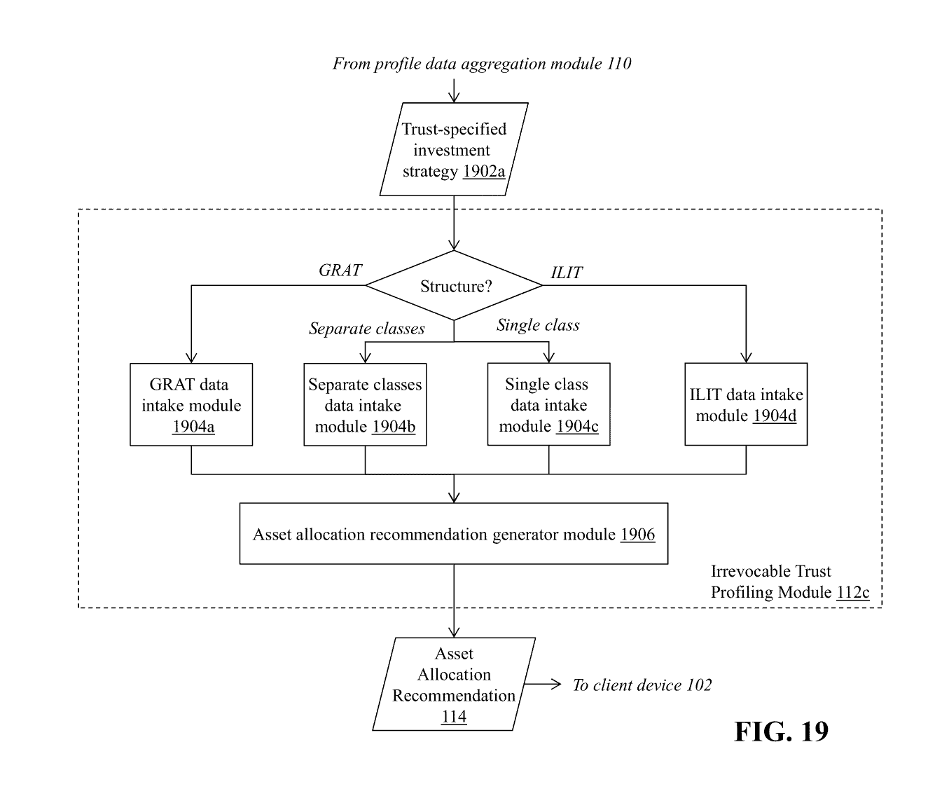

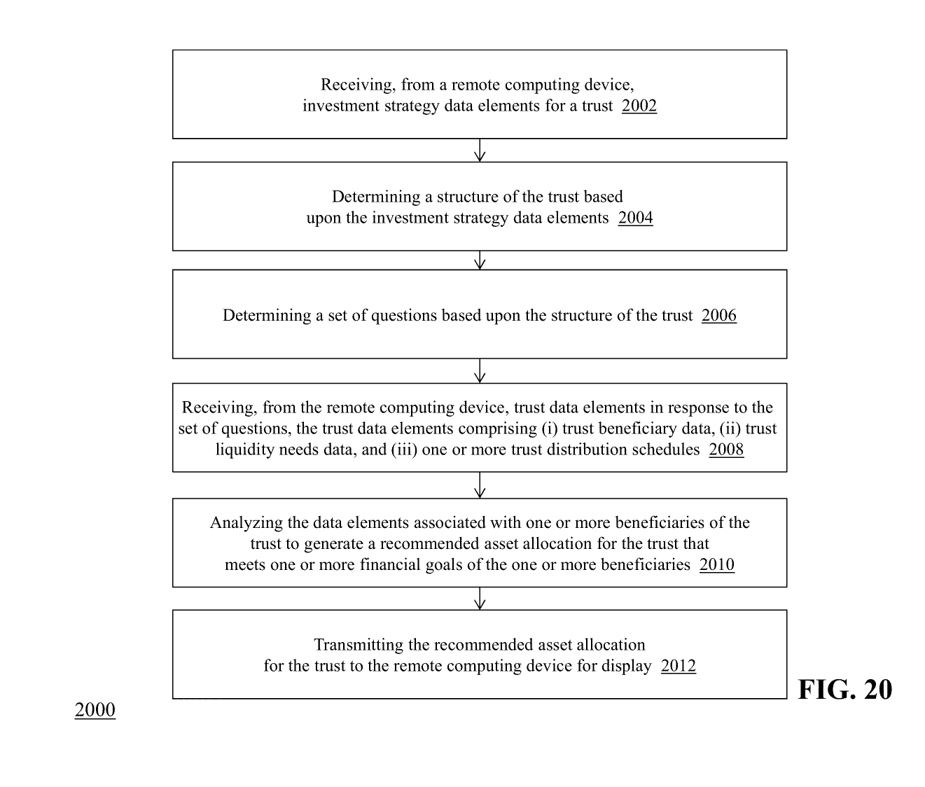

FIG. 19 is a detailed block diagram of the irrevocable trust profiling module 112c, for generating an asset allocation recommendation. FIG. 20 is a flow diagram of a method 2000 for generating an asset allocation recommendation for a trust. The profile data aggregation module 110 receives (2002) data elements regarding an investment strategy specified in the trust documentation 1902a from, e.g., client device 102. The profile data aggregation module 110 transmits the trust-specified investment strategy data elements 1902a to the irrevocable trust profiling module 112c for analysis and generation of an irrevocable trust asset allocation recommendation.

The irrevocable trust profiling module 112c receives trust-specified investment strategy data elements 1902a and analyzes the data elements to determine (2004) the structure of the trust. Depending on the structure of the trust, the irrevocable trust profiling module 112c initiates one of a plurality of intake modules 1904a-1904d to determine (2006) a set of questions with which to obtain additional information about the trust from, e.g., client device 102. The intake modules include a GRAT data intake module 1904a, a separate beneficiary classes data intake module 1904b, a single beneficiary class data intake module 1904c, and an ILIT data intake module 1904d. The module 112c uses different modules 1904a-1904d depending upon the structure of the trust because the data elements required to generate and provide an asset allocation recommendation vary between different types of structures. It should be appreciated, however, that some of the data elements can be shared between each structure type.

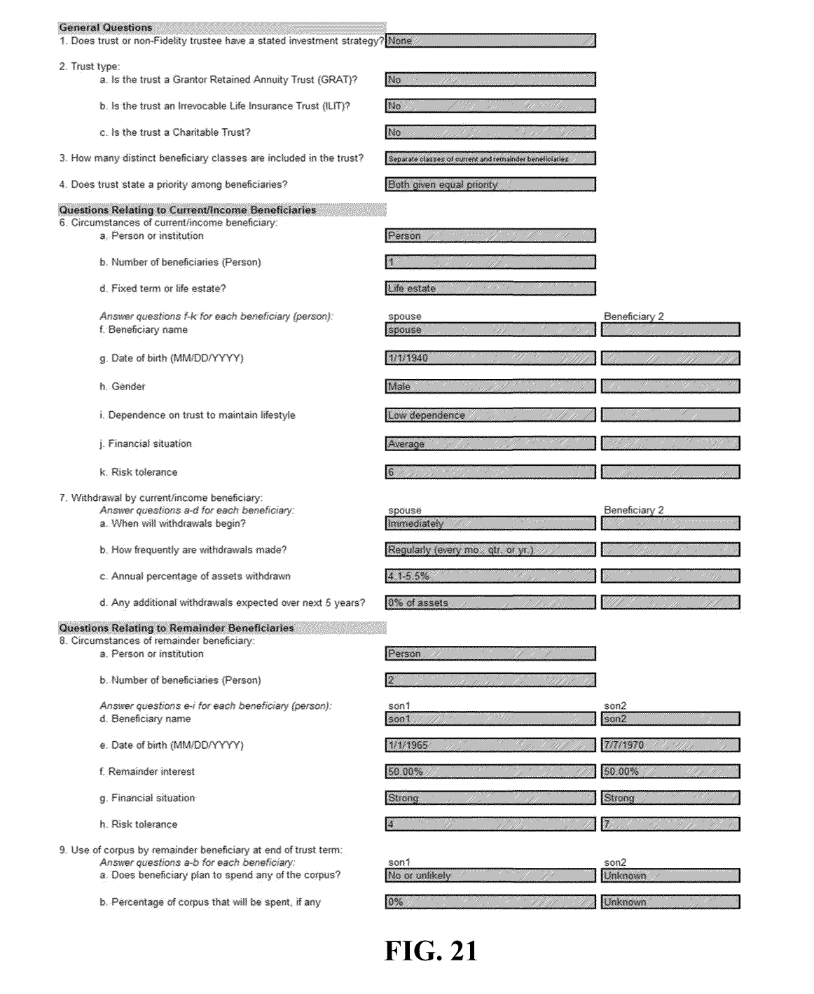

FIG. 21 is an exemplary data intake form generated by the separate classes data intake module 1904b for a trust having separate beneficiary classes. As shown in FIG. 21, the form includes data element requests relating to the trust as a whole, requests relating to current/income beneficiaries' circumstances and liquidity needs, and requests relating to remainder beneficiaries' circumstances and liquidity needs.

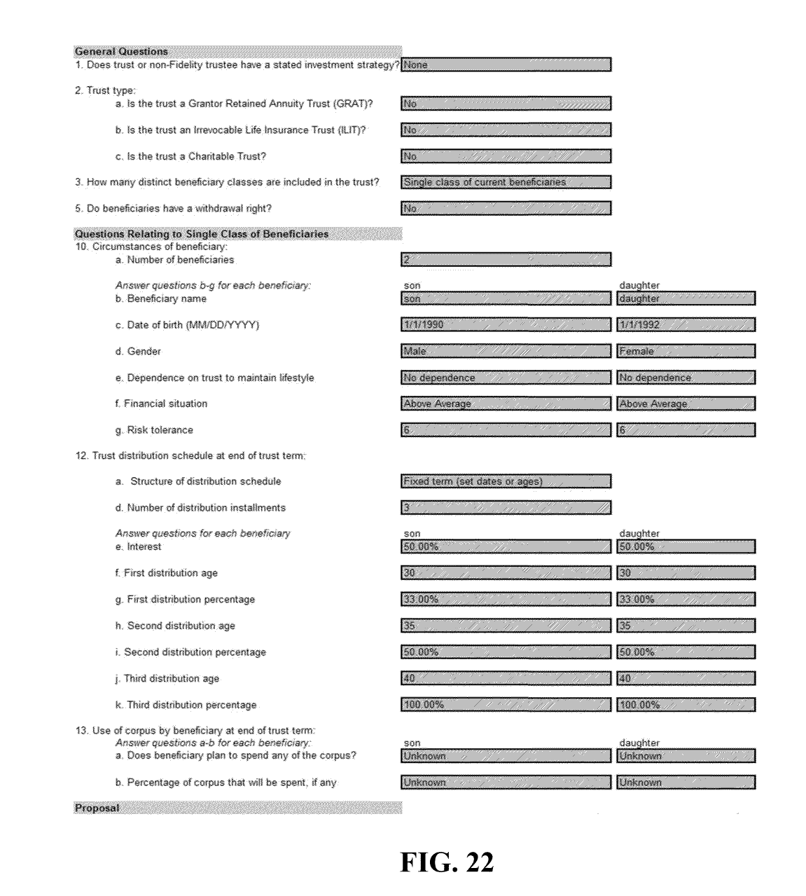

FIG. 22 is an exemplary data intake form generated by the single class data intake module 1904c for a trust having one class of beneficiary. As shown in FIG. 22, the form includes data element requests relating to the trust as a whole and requests relating to the single class of beneficiaries' circumstances, use of corpus, and the trust-specified distribution schedule.

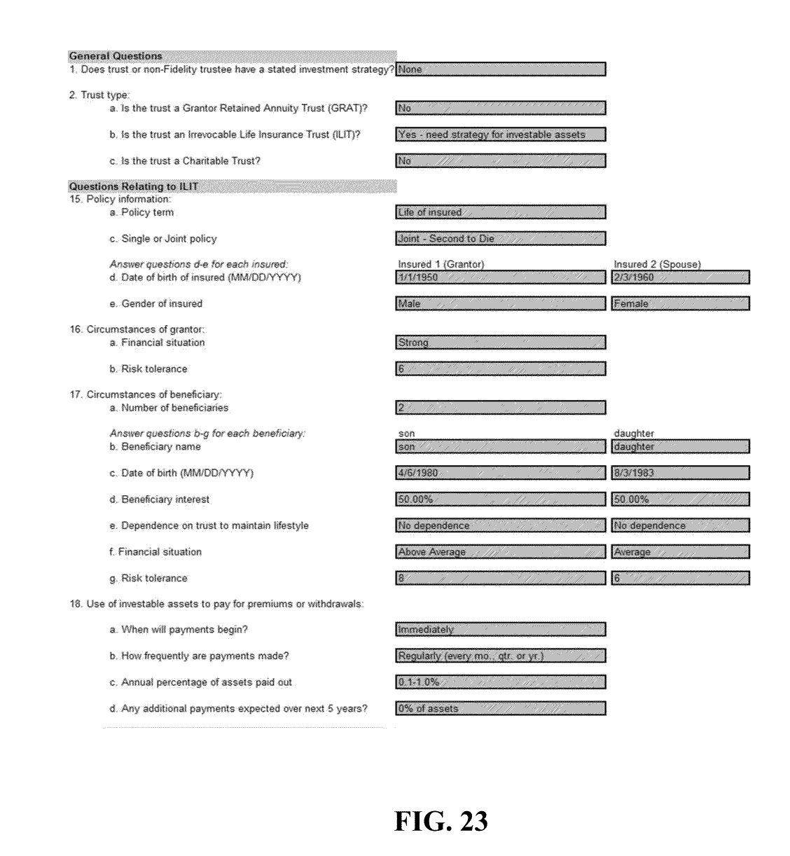

FIG. 23 is an exemplary data intake form generated by the ILIT data intake module 1904d for an ILIT trust. As shown in FIG. 23, the form includes data elements relating to the trust as a whole and requests relating to the ILIT policy information, grantor circumstances, beneficiary circumstances, and liquidity of the investable assets.

Turning back to FIG. 19, once the respective intake modules 1904a-1904d have received (2008) data elements relating to the specific trust structure, such as trust beneficiary data, trust liquidity needs data, and one or more trust distribution schedules, from, e.g., the client device 102, the asset allocation recommendation generator module 1906 analyzes (2010) the incoming data elements and generates a recommended asset allocation 114 for the trust that is customized according to the specification of the trust. The generator module 1906 transmits (2012) the recommendation 114, e.g., to client device 102 for display to a user.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for generating an asset allocation recommendation for a trust, the method comprising:
receiving, by a server computing device from a remote computing device, investment strategy data elements for a trust;
determining, by the server computing device, a structure of the trust based upon the investment strategy data elements;
determining, by the server computing device, a set of questions based upon the structure of the trust;
receiving, by the server computing device from the remote computing device, trust data elements in response to the set of questions, the trust data elements comprising (i) trust beneficiary data, (ii) trust liquidity needs data, and (iii) one or more trust distribution schedules;
analyzing, by the server computing device, the data elements associated with one or more beneficiaries of the trust to generate a recommended asset allocation for the trust that meets one or more financial goals of the one or more beneficiaries; and
transmitting, by the server computing device, the recommended asset allocation for the trust to the remote computing device for display.

2. The method of claim 1, wherein display of the recommended asset allocation for the trust on the remote computing device comprises generating a dashboard configured to receive data elements associated with one or more beneficiaries of the trust and display the corresponding recommended asset allocation for the trust.

3. The method of claim 2, wherein the dashboard displays the recommended asset allocation in real-time.

4. The method of claim 1, wherein the structure of the trust comprises a Grantor Retained Annuity Trust (GRAT), an Irrevocable Life Insurance Trust (ILIT), a trust having a single beneficiary class, or a trust having a plurality of separate beneficiary classes.

5. The method of claim 1, wherein the investment strategy data elements are based upon documentation associated with formation of the trust.

6. The method of claim 1, wherein the investment strategy data elements comprise an investment objective of the trust and structure data associated with the trust.

7. The method of claim 1, wherein the demographic data elements comprise a current age of a beneficiary of the trust and a gender of a beneficiary of the trust.

8. The method of claim 1, wherein the risk tolerance data elements include a level of investment risk that a beneficiary of the trust is willing to assume, a level of dependence that a beneficiary of the trust has on income from the trust, and a level of financial security attributable to a beneficiary of the trust.

9. The method of claim 1, wherein the financial goal data elements for a trust having multiple classes of beneficiaries comprise a withdrawal amount available to a current beneficiary of the trust, a frequency of withdrawals to be made by a current beneficiary of the trust, and an amount of trust corpus to be spent by a remainder beneficiary of the trust.

10. The method of claim 9, wherein the withdrawal amount comprises an annual percentage of assets withdrawn from the trust.

11. A computerized system for generating an asset allocation recommendation for a trust, the system comprising a server computing device configured to:
receive, from a remote computing device, investment strategy data elements for a trust;
determine a structure of the trust based upon the investment strategy data elements;
determine a set of questions based upon the structure of the trust;
receive, from the remote computing device, trust data elements in response to the set of questions, the trust data elements comprising (i) trust beneficiary data, (ii) trust liquidity needs data, and (iii) one or more trust distribution schedules;
analyze the data elements associated with one or more beneficiaries of the trust to generate a recommended asset allocation for the trust that meets one or more financial goals of the one or more beneficiaries; and
transmit the recommended asset allocation for the trust to the remote computing device for display.

12. The system of claim 11, wherein the server computing device is configured to generate a dashboard to receive data elements associated with one or more beneficiaries of the trust and display the corresponding recommended asset allocation for the trust.

13. The system of claim 12, wherein the dashboard displays the recommended asset allocation in real-time.

14. The system of claim 11, wherein the structure of the trust comprises a Grantor Retained Annuity Trust (GRAT), an Irrevocable Life Insurance Trust (ILIT), a trust having a single beneficiary class, or a trust having a plurality of separate beneficiary classes.

15. The system of claim 11, wherein the investment strategy data elements are based upon documentation associated with formation of the trust.

16. The system of claim 11, wherein the investment strategy data elements comprise an investment objective of the trust and structure data associated with the trust.

17. The system of claim 11, wherein the demographic data elements comprise a current age of a beneficiary of the trust and a gender of a beneficiary of the trust.

18. The system of claim 11, wherein the risk tolerance data elements include a level of investment risk that a beneficiary of the trust is willing to assume, a level of dependence that a beneficiary of the trust has on income from the trust, and a level of financial security attributable to a beneficiary of the trust.

19. The system of claim 11, wherein the financial goal data elements for a trust having multiple classes of beneficiaries comprise a withdrawal amount available to a current beneficiary of the trust, a frequency of withdrawals to be made by a current beneficiary of the trust, and an amount of trust corpus to be spent by a remainder beneficiary of the trust.

20. The system of claim 19, wherein the withdrawal amount comprises an annual percentage of assets withdrawn from the trust.

21. A computer program product, tangibly embodied in a non-transitory computer readable storage medium, for generating an asset allocation recommendation for a trust, the computer program product including instructions operable to cause a server computing device to:
receive, from a remote computing device, investment strategy data elements for a trust;
determine a structure of the trust based upon the investment strategy data elements;
determine a set of questions based upon the structure of the trust;
receive, from the remote computing device, trust data elements in response to the set of questions, the trust data elements comprising (i) trust beneficiary data, (ii) trust liquidity needs data, and (iii) one or more trust distribution schedules;
analyze the data elements associated with one or more beneficiaries of the trust to generate a recommended asset allocation for the trust that meets one or more financial goals of the one or more beneficiaries; and
transmit the recommended asset allocation for the trust to the remote computing device for display.
